(19) United States
(12) Patent Application Publication
(10) Pub. No.: US 2009/0099312 A1
(43) Pub. Date: Apr. 16, 2009

(54) Amine terminated tougheners for epoxy resin based adhesives and materials

(76) Inventors: Carl Duane Weber, Copley, OH (US); David Richard Egan, Stow, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/974,606

(22) Filed: Oct. 15, 2007

(51) Int. Cl. C08L 77/00

(52) U.S. Cl. 525/181

(57) ABSTRACT

An uncured liquid epoxy composition comprises a liquid epoxy resin and a) a tri-amine terminated polyether toughener optionally adducted with an epoxy resin, or a mixture of said tri-amine terminated polyether toughener optionally have an epoxy adduct thereon with a core-shell copolymer or with an epoxidized carboxyl terminated butadiene-acrylonitrile copolymer; or b) an amine terminated tri-block polyether toughener optionally adducted with an epoxy resin, or a mixture of said amine terminated tri-block polyether toughener optionally having an epoxy adducted thereon with a core-shell copolymer or with an epoxidized carboxyl terminated butadiene-acrylonitrile copolymer. The uncured toughener composition need not contain any high molecular weight polymers or material and is utilized as a low viscosity paste adhesive having good storage stability, and when cured has very good low temperature peel strength at minus 40° C. along with very good ambient temperature toughness which correlates with improved higher speed impact resistance. The epoxy compositions are suitable for use as an adhesive in the aerospace or automotive fields wherein good low temperature performance properties and improved resistance to impact are desired.

### FIELD OF THE INVENTION

The present invention relates to toughened epoxy compositions that can be used as an adhesive or other material and do not contain high molecular weight epoxy resins including solid epoxies or linear polymers. The epoxy compositions have low viscosity at room temperature and good storage stability, and when cured have unexpectedly high peel strength at very low temperatures such as from about minus 20° C. to about minus 65° C. and also have improved toughness at ambient temperature as demonstrated by higher peel strength and impact resistance. These materials can be blended with other tougheners allowing for the use of significantly high amounts of toughener yielding very high toughness without significant loss in mechanical properties and glass transition temperature, Tg. The invention comprises several embodiments including:
1. A neat liquid tri-primary amine terminated polyether (tri-amine) used as the sole toughener.
2. Embodiment 1 above adducted with epoxy resin and used as the sole toughener.
3. Embodiment 1 or 2 blended with core-shell particles (co-tougheners).
4. Embodiment 1 or 2 blended with an epoxy adduct of an acid terminated liquid co-polymer of butadiene-acrylonitrile such as Hycar® CTBN (co-tougheners).
5. A liquid primary amine terminated tri-block polyether (tri-block) used as the sole toughener.
6. Embodiment 5 adducted with epoxy resin as sole toughener.
7. Embodiment 5 or 6 blended with core-shell particles (co-tougheners).
8. Embodiment 5 or 6 blended with an epoxy adduct of an acid terminated liquid co-polymer of acrylonitrile-butadiene (CTBN) (co-tougheners).
9. Embodiment 9, a neat liquid di-primary amine terminated polyether (di-amine) used as the sole toughener.
10. Embodiment 9 above adducted with epoxy resin and used as the sole toughener.
11. Embodiment 9 or 10 blended with core-shell particles (co-tougheners).
12. Embodiment 9 or 10 blended with an epoxy adducted of an acid terminated liquid co-polymer of butadiene-acrylonitrile (CTBN) (co-tougheners).

As a very broad, non-inclusive, overview, the present invention generally relates to amine terminated compounds that serve as tougheners for an expoxy resin as well as to such compounds adducted with an epoxy resin. The present invention also generally relates to blending of the various tougheners.

With respect to adduction, the same is prepared by reacting acid groups such as those of Hycar® CTBN or amine hydrogens of primary amine functional polyalkylene oxides with an excess of epoxy resin where the acid group or amine hydrogen group reacts with the epoxide group to form an epoxy terminated polymer dispersed in epoxy resin. The reacting of the terminal acid groups of Hycar® CTBN with epoxide groups is well documented. The reaction of amine hydrogens can be accomplished at ambient temperatures or at temperatures ranging from about 80° C. to about 100° C. For instance, Jeffamine T-3000®, a primary amine terminated polypropylene oxide, can be reacted with excess Epalloy® 8225 (bis F based epoxy from CVC) at a ratio of 40 parts of T-3000® to 60 parts of Epalloy® 8225. This is a ratio of 4.6 to 1 of epoxide groups to amine hydrogen groups.

The amount of toughener in the immediately above adduct is considered to be 40%. When formulating an adhesive, 25 parts of this adduct would yield 10 parts of toughener. The formulation is adjusted to take in to account the extra 15 parts of epoxy resin that is part of the adduct.

Representative Adhesive Formulation

| Ingredient | Parts |
|---|---|
| Epon 828 ® | 85 |
| Adduct mentioned above | 25 |
| Dicyandiamide | 5 |
| Amicure ® UR | 2 |
| Cab-O-Sil ® TS 720 | 3 |
| Filler | 5-40 |

With respect to the various polyalkylene oxide tougheners and epoxy adducted polyalkylene oxide tougheners with other conventional tougheners, they include the following:

Polyalkylene Oxide Blends with Core-Shell Polymers

The core-shell particles are dispersed in a polyalkylene oxide resin for about 2 to about 4 hours at about 25° C. to about 80° C. to form a blend. Alternatively, the core-shell particles can be dispersed in an epoxy resin and mixed therewith a primary amine terminated polyalkylene oxide polymer subsequently added to the mixture and reacted at about 80° C. for at least 4 hours to form a blend of the core-shell polymers and the epoxy adducted polyalkylene oxide compound.

Representative Formulation of a Blended Toughener System*
25 parts of core-shell
75 parts of Epalloy 8225 or blends with Epon 828**
25 parts of T-3000 (or Jeffamine D 2000, or a block polyalkylene oxide such as Jeffamine XTJ 542 copolymer)
*Adduct-blend contains 40% toughener which in this case is a 1 to 1 ratio of core-shell to T-3000.
**The epoxy resins, Epalloy 8225 and Epon 828, can be blended as long as the viscosity remains low enough to be easily added to formulations.

The ratio of core-shell to polyalkylene oxide can be varied to provide either the lowest viscosity or the optimum mechanical properties when formulated to prepare adhesives or materials.

In lieu of core-shell polymers, Hycar CTBN can be utilized in a similar manner to form a blend of a CTBN and polyalkylene oxide amine terminated compounds, or a blend of a Hycar CTBN and epoxy adducted polyalkylene oxide compound. The latter blend is formed by reacting Hycar CTBN with epoxy resin at about 110° C. to about 130° C. until the acid number is reduced to about 0.001 ephr*. This adduct is cooled and the amine terminated polyalkylene oxide is added and reacted at about 80° C. for about 4 to about 6 hours.
Representative Formulation of Blended Tougheners**
75 parts of Epalloy 8225 or Epon 828 or blends
25 parts of Hycar 1300X13 or Hycar 1300X8 or blends
25 parts of D 2000 (T-3000 or block polyalkylene oxide copolymer such as XTJ 542)
*ephr is equivalent of acid groups per 100 parts of adduct
**Formulation contains 40% toughener and the ratio of tougheners (Hycar 1300X13 to D 2000) is 1 to 1.

The ratio of Hycar RLP to polyalkylene oxide can be varied to provide either the lowest viscosity or the optimum mechanical properties when formulated to prepare adhesives or materials.

### BACKGROUND OF THE INVENTION

Heretofore, epoxy resins have been mixed with low amounts of toughener such as reactive liquid polymers (e.g. 5-15 parts toughener per 100 parts of epoxy resin) to form an epoxy resin composition having improved toughness. Generally, the reactive liquid polymers are adducted with epoxy resin prior to addition to the epoxy resin compounds. These adducts are soluble in the epoxy resin and thus are dispersed therein so that upon heat curing a phase separation generally occurs whereby the reactive liquid polymer forms micron sized particles throughout the epoxy resin. With the more soluble tougheners it is believed that some material remains in solution and acts to increase the ductility of the matrix resin and as a result causes a slight decrease in the glass transition temperature (Tg) and an additional improvement in the level of toughness. Prior common tougheners are generally low molecular weight carboxyl terminated copolymers of a diene monomer, such as butadiene, with co-monomer such as acrylonitrile, for example carboxyl terminated nitrile rubbers. It is believed that the optimum level of a toughener of this type is about 15 parts for maximum toughness (measured by T-peel strength for adhesives). Higher levels, i.e. about 18 parts to 40 parts of toughener per 100 parts of epoxy resin, actually can give lower peel strength and mechanical properties, due to phasing transformation. At very high levels, for instance greater than about 40 parts, the products can become more rubbery in nature and exhibit a significant decrease in Tg. Examples of other epoxy tougheners are set forth in the following U.S. Patents.

Various amine terminated compounds of epoxy resins are set forth in U.S. Pat. Nos. 4,886,867 and 4,940,770, both assigned on their face to Texaco Chemical Company, and U.S. Pat. No. 5,399,663, assigned on its face to Huntsman Corporation.

U.S. Pat. Nos. 6,015,865; 6,776,869; and 6,998,011, all assigned on their faces to Henkel, generally relate to reactive hot melt adhesives containing an epoxy resin, or an impact-resistant epoxy resin composition.

Polyurea polymers prepared from a polyamine epoxide adduct are set forth in U.S. Pat. No. 6,723,821, assigned on its face to Hehr International.

Epoxy toughening compositions derived from the reaction of one or more isocyanate terminated prepolymers and one or more capping compounds are set forth in International Publication WO 2005/007766, assigned on its face to Dow Global Technologies Inc.

Various epoxy systems modified with reactive liquid polymers or tougheners are set forth in several patents assigned on their face to the B.F. Goodrich Company and include U.S. Pat. Nos. 3,966,837; 4,290,939; 5,053,496; 5,080,968; 5,140,068; 5,157,077; 5,198,510; 5,268,452; 5,280,068; 5,300,584; 5,312,956; and 5,393,850.

### SUMMARY OF THE INVENTION

The toughened epoxy compositions of the present invention comprise a tri-amine terminated polyalkylene oxide, having a weight average molecular weight of from about 2,000 to about 4,000, wherein the alkylene oxide has 3 or 4 carbon atoms and is generally utilized in an amount of from about 5 to about 30 parts by weight per 100 total parts by weight of a liquid epoxy resin. The tri-amine terminated polyalkylene oxide toughener can be adducted with an epoxy resin wherein the amount of toughener in the epoxy adduct is generally from about 10% to about 60% by weight.

Another form of this toughener comprise blends of the above-noted epoxy adducted or non-adducted tri-amine terminated polyalkylene oxide compound with a conventional core-shell copolymer wherein the core can be prepared from various vinyl-containing monomers such as a conjugated diene and styrene and the shell can be prepared from an alkyl acrylate, preferably methyl methacrylate, or styrene monomer. The amount of the core-shell copolymer can generally range from about 5 to about 30 parts by weight based upon 100 total parts by weight of the epoxy resin.

Another form of the toughener includes a blend of the above-noted epoxy adducted or non-adducted tri-amine terminated polyalkylene oxide compound with an epoxy adduct of a carboxylated butadiene-acrylonitrile copolymer (CTBN). The amount of CTBN toughener per se generally ranges from about 5 to about 30 parts by weight per 100 total parts per weight of the epoxy resins.

Yet another epoxy toughener of the present invention comprises a di-amine terminated polyalkylene oxide, having a weight average molecular weight of from about 1,000 to about 3,000, wherein the alkylene oxide has from 3 or 4 carbon atoms and is generally utilized in an amount of from about 5 to about 30 parts by weight per 100 total parts by weight of the liquid epoxy resin. The di-amine terminated polyalkylene oxide toughener can be adducted with an epoxy resin wherein the amount of toughener in the epoxy adduct is generally from about 10% to about 60% by weight.

Other forms of the di-amine toughener blends of the present invention comprise the di-amine terminated polyalkylene oxide toughener either adducted or non-adducted, with a conventional core-shell polymer as noted hereinabove with respect to the tri-amine terminated polyalkylene oxide toughener. The amount of the core-shell copolymer can generally range from about 5 to about 30 parts by weight based upon 100 total parts by weight of the epoxy resin.

Another form of the toughener includes a blend of the above-noted epoxy adducted or non-adducted di-amine terminated polyalkylene oxide compound with an epoxy adducted carboxylated butadiene-acrylonitrile copolymer (CTBN). The amount of the CTBN toughener per se generally ranges from about 5 to about 30 parts per 100 total parts by weight of the epoxy resins.

Still another epoxy toughener of the present invention includes an amine terminated tri-block polyether wherein the tri-block is generally prepared from two or more different polyalkylene oxide monomers having from 3 or 4 carbon atoms. An important aspect of the amine terminated tri-block polyether is that it has a low weight average molecular weight as from about 800 to about 2,000. The tri-block polyether toughener can also be adducted with an epoxy resin wherein the amount of the toughener ranges from about 10% to about 60% by weight. The epoxy adducted or non-adducted amine terminated tri-block polymer can also be blended with a core-shell copolymer or an epoxy adduct of a carboxylated terminated liquid butadiene-acrylonitrile copolymer (CTBN) in similar ratios as for the tri-amines, to provide exceptional toughness at low and ambient temperatures.

The adducted and non-adducted tri-amines, di-amines, or tri-block when added to core shell or CTBN adducts provide high levels of toughness without the use of higher molecular weight epoxy resins, extenders or other higher molecular weight poly ethers and provide excellent low temperature and room temperature peel strength. However, higher molecular weight epoxy resins and polymers can be used to obtain even greater levels of toughness if higher viscosity can be tolerated.

### DETAILED DESCRIPTION OF THE INVENTION

Selected types of amine terminated polyethers are utilized as tougheners generally for epoxy resins to form liquid pre-cure blends thereof that have relatively low viscosity and good storage life or stability. The epoxy resins are generally known to the art and to the literature and can be various commercially available epoxy resins. Examples of these epoxy resin or polymers include; glycidyl ethers of novolac resins such as epoxylated phenol-formaldehyde novolac resin; glycidyl ethers of mono-, di-, and trihydric phenols; glycidyl ethers of bisphenols such as diglycidyl ether of tetrabromobisphenol A; glycidyl ethers of polynuclear phenols; epoxy resin made from diphenolic acid; glycidyl ethers of aliphatic polyols: glycidyl esters such as aliphatic diacid glycidyl esters and epoxidized fatty acids; glycidyl epoxies containing nitrogen such as glycidyl amides and amide-containing epoxies; glycidyl derivatives of cyanuric acid; glycidyl resins from melamines; glycidyl amines such as triglycidyl ether amine of p-aminophenol and bis(2,3-epoxypropyl)methylpropylammonium p-toluenesulfonate; glycidyl triazines; thioglycidyl resins such as epoxidized bisulfide; silicon-glycidyl resins such as 1,4-bis[(2,3-epoxypropoxy)dimethylsilyl]; and fluorine glycidyl resins. Other epoxy resins that can be utilized include resins synthesized from mono-epoxies other than epihalohydrins including epoxy resins made from unsaturated monoepoxies such as polyallyl glycidyl ether and glycidyl sorbate dimer; epoxy resins from monoepoxy alcohols; epoxy resins from monoepoxies by ester interchange; epoxy resins from glycidaldehyde; polyglycidyl compounds containing unsaturation such as allyl-substituted diglycidyl ether of bisphenol A; epoxy-resin adducts of the above; and epoxy resins that are synthesized from olefins and chloroacetyls such as butadiene dioxide, vinylcyclohexene dioxide, epoxidized polybutadiene, and bis(2,3-epoxycyclopentyl)ether. A more comprehensive list of epoxy resins can be found in Handbook of Epoxy Resins, by Henry Lee and Kris Neville, McGraw-Hill, Inc., 1967, which is hereby fully incorporated by reference.

A highly preferred epoxy resin is diglycidyl ether of bisphenol A (DGEBA) that has the following formula:

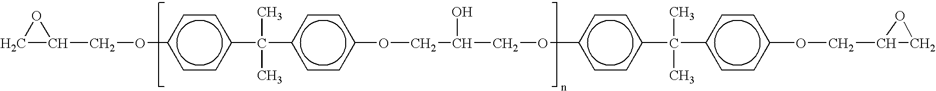

wherein n is from 0 or about 0.1 to about 5, desirably from 0 or about 0.1 to about 3.5, and preferably from 0 or about 0.1 to about 3.0. Other preferred epoxies include diglycidyl ethers of bisphenol F wherein n is less than 1.0. Other epoxy resins that can be used in this invention include lower viscosity resins other than a typical liquid DGEBA resin (molecular weight of about 400) and the DGEBF resins. Di-functional aliphatic epoxies and dimer acid epoxy resins commonly considered as diluents or flexibilizers in epoxy formulations include neopentyl glycol diglycidyl ether, 1,4-butanediol diglycidyl ether and cyclohexanedimethanol diglycidyl ether. Such resins could be used judiciously to favorably affect viscosity but not at a level that would compromise mechanical properties (desirably less than about 10 parts by weight per 100 total parts by weight of all epoxies).

The various epoxy resins or polymers generally have a weight average molecular weight of from about 200 to about 13,000, and desirably from about 340 to about 1,200. The preferred epoxy polymers generally are di-functional, that is, they have two epoxide groups typically at the terminal portions thereof. Small amounts of epoxy resins with functionality greater than 2 may be used judiciously to modify Tg or other mechanical properties.

A desired toughener is a liquid tri-amine terminated polyether such as a polyalkylene oxide that is a low molecular weight polymer having three side chains each terminated with a primary amine group. The tri-amine is prepared by reacting alkylene oxide with a triol initiator followed by amination of the terminal hydroxyl group. Each monomer can contain 3 or 4 carbon atoms and thus can be propylene oxide, or butylene oxide, or combinations thereof, with propylene oxide being highly preferred. The weight average molecular weight of the tri-amine terminated polyalkylene oxide is generally from about 2,000 to about 4,000, desirably from about 2,500 to about 3,500, and preferably from about 2,800 to about 3,200. The formulation of a highly preferred tri-amine is as follows:

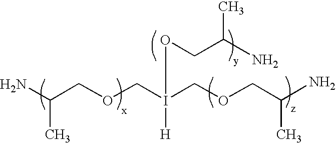

Where I is derived from a conventional initiator and x+y+z is from about 30 to about 70 moles, desirably form about 40 to about 60 moles, and preferably from about 45 to about 55 moles. Such a compound is commercially available as JEFFAMINE® tri-amine (T series), i.e. T-3000 from Huntsman Corporation of The Woodlands, Tex. The preferred terminal amine group is a primary amine, i.e.—NH₂ as shown, or less preferred other amines such as secondary amines. Higher molecular weight polyalkylene oxides having two terminal amine groups, and a weight average molecular weight greater than 3,200 are not preferred inasmuch as they do not yield toughness properties equivalent to those as set forth herein below. The liquid toughened epoxy resins of the present invention thus desirably contain low amounts of high molecular weight di-amine terminated polyalkylene oxides such as about 25 parts by weight or less, desirably 10 or 5 parts by weight or less, and preferably no parts by weight of the high molecular weight di-amine terminated compounds based upon 100 parts by weight of the epoxy resin.

The amount of the tri-amine terminated polyalkylene oxide tougheners of the present invention when used as the sole toughener, generally range from about 5 to about 30 parts by weight, desirably from about 5 to about 25 parts by weight, and preferably from about 13 to about 18 parts by weight per 100 parts by weight of the one or more above-noted epoxy resins as well as the here in below adducted epoxy resins when present, or any other epoxy source.

Although the tri-amine terminated polyalkylene oxide toughener can be utilized “as is” with the various above-noted one or more epoxy resins, it is highly desirable to adduct the tri-amine with an epoxy resin since this improves the solubility of the toughener in the epoxy resin and also improves the stability of the viscosity of compounded epoxy resins when aged at ambient conditions prior to bonding because the adduct no longer contains active amine hydrogens. The epoxy that can be utilized as an adduct is generally a low molecular weight di-functional epoxy resin meaning that the resin utilized has two epoxy end groups and thus while epoxy novolacs and resoles with functional greater than 2 are not preferred, generally all of the other types of epoxy resins set forth hereinabove if compatible with the tri-amine, hereby fully incorporated by reference, can be utilized. A key consideration in preparing adducts is to obtain a useable low viscosity which facilitates incorporation of the toughener into an epoxy compound. Based on the required mechanical properties for adhesives and other materials the preferred epoxy resins used for adducting to tri-primary amine terminated polyethers are diglycidyl ethers of bisphenol A (DGEBA) and bisphenol F (DGEBF). Bisphenol F is generally preferred if a lower viscosity is to be achieved. Lower viscosity epoxies such as neopentyl glycol diglycidyl ether, 1,4-butane diol diglycidyl ether, cyclohexanedimethanol diglycidyl ether and other low viscosity difunctional epoxys may be added in amounts less than 20 parts based on 100 parts of either DGEBA or DGEBF or combinations of DGEBA and DGEBF to lower the viscosity of tri-amine adducts. The ratio of epoxy resin to tri-amine toughener in preparing the adducts is selected to provide a ratio of epoxy equivalents to amine equivalents of greater than about 4.0 to 1 and desirably greater than about 5.1 to 1. A significant excess of epoxide equivalents must be present in order to avoid high viscosity or gelation of these adducts.

When a tri-amine terminated polyalkylene oxide-epoxy adduct toughener is utilized, generally all of the tri-amine in the epoxy blend composition is used in the tri-amine-epoxy adduct compound. However, it is within the scope of the present invention only a very small portion, such as for example about 1% or 2% by weight to all of the tri-amine, is utilized in the tri-amine-epoxy adduct toughener. The amount of the tri-amine in the tri-amine-epoxy adduct compound is generally from about 10% to about 60%, desirably from about 15% to about 50%, and preferably from about 25% to about 50% by weight based upon the total weight of the tri-amine-epoxy adduct compound.

The adduction of an epoxy onto the tri-amine terminated polyalkylene oxide generally involves mixing the tri-amine terminated polyether with an epoxy resin and reacting at temperatures of about 25° C. for about 2 weeks or at about 100° C. for about 4 hours. Preferable reacting conditions are about 4 to about 10 hours at about 80° C. See Table 1.

TABLE 1
Viscosities of Tougheners and Adducts

| | Epoxide*/ | Viscosity cps |
|---|---|---|
| Toughener/Adducts | N—H equiv. | @ 27° C. |
| Epon ® 828 | — | 11,000-15,000 |
| Epalloy ® 8225 | — | |
| EPON 58005 Adduct (40% CTBN 1300 X13 in Epon828) | — | 450,000 |
| (Control) | | |
| Non-adducted T-3000 | — | 485 |
| Non-adducted XTJ ® 542 (tri-block) | — | 215 |
| 7/3 Adduct Epon 828/XTJ 542 | 3.7/1 | 1,700,000 |
| (epoxy adducted tri-block) | | |
| 2/1 adduct Epon 828/XTJ 533 | 3.5/1 | 75,000 |
| (epoxy adducted tri-block) | | |
| 60/40 adduct of Epalloy 8225 and D 2000 | 4.4/1 | 82,000 |
| 60/40 adduct of Epon 828 and D 2000 | 3.9/1 | 167,000 |
| Non-adducted T-3000 (tri-amine) | — | 485 |
| 60/40 adduct of Epalloy 8225/T-3000 | 4.6/1 | 210,000 |
| (epoxy adducted tri-amine) | | |
| 67/33 adduct of Epon 828/T-3000 ® ** | 5.3/1 | 207,000 |
| (epoxy adducted tri-amine) | | |
| 67/33 adduct of Epalloy ® 8225/T-3000 | 6/1 | 67,000 |
| (epoxy adducted tri-amine) | | |
| 60/40 adduct of 30% Epon 828, 30% Epalloy 8225, | — | 440,000 |
| 20% T-3000, and 20% Hycar 1300X13 | | |

Epalloy 8225 in a diglycidylether of bisphenol F CVC Corporation

Another epoxy toughener of the present invention are various blends comprising core-shell polymers and the above-noted tri-amine terminated polyalkylene oxide polymers, whether adducted with epoxy or not. The amount of the core-shell polymer used in toughening 100 total parts by weight of epoxy is generally limited by viscosity and typically is from about 5 to about 30 parts by weight, desirably from 10 to about 30 parts by weight and preferably from about 15 to about 25 parts by weight. As noted, for lower viscosity, the epoxy resin used in blend-adducts may be composed of either a liquid diglycidyl ether of bisphenol A, a liquid diglycidyl ether of bisphenol F, or mixtures thereof.

The core-shell polymer can be conventional polymers that have a low core Tg of about minus 25° C. or less and preferably about minus 45° C. or less. Such polymers generally have a core made from various dienes containing from 4 to 6 carbon atoms such as butadiene, and copolymers made with small amounts, e.g. about 20% by weight or less, of various vinyl substituted aromatics having from 8 to about 12 carbon atoms such as styrene. Another group of core polymers are made from various alkyl acrylates wherein the alkyl portion has from 4 to about 15 carbon atoms with from about 4 to about 8 carbon atoms being desired and butyl or 2-ethyl hexyl being preferred. The core polymers can be lightly crosslinked, utilizing compounds are well known to the art and to the literature as for instance divinyl benzene or poly functional acrylates.

A thin hard layer shell is added to the core to keep adjacent cores from sticking to one another. Any suitable polymer can be utilized such as various alkyl alkyl methacrylates, wherein the alkyl group generally has 1 to 4 carbon atoms with methyl being highly preferred. Shell polymers can also be lightly crosslinked utilizing compounds that are well known to the art and to the literature as for instance divinyl benzene or poly functional acrylates. Shell polymers can be functionalized with epoxy groups, acids or other functional groups utilizing glycidyl methacrylate of acrylic or methacrylic acids and the like. The polarity of the shell can also be altered by using small amounts of polar monomers such as acrylonitrile. Core-shell polymers are known to provide toughness without significant lowering of the Tg since they are almost completely insoluble in the epoxy resin and are already formed into sub-micron sized particles. Since core-shell particles are not dissolved in the matrix resin their presence does not increase the ductility of the matrix resin itself. Blends of the tri-amine and the core-shell polymers can be used at high levels of toughener, i.e., about 15 parts by weight of core-shell and about 15 parts by weight of tri-amine per 100 parts by weight of all epoxies, with an unexpected level of improvement in toughness and minimizing loss of the Tg. All core-shell polymers toughen by the same mechanism, i.e. nano-meter sized particles act to toughen the epoxy or thermoset resin. Therefore the tri-amine and tri-block co-tougheners will work well with any core-shell polymers.

Utilization of tri-amine terminated polyalkylene oxide and core-shell blends are best achieved by preparing blend adducts of the tri-amine. Blend adducts are prepared in one embodiment by mixing core-shell particles, the tri-amine and the epoxy resin at about 80° C. for 4 to 8 hours. Tri-amine-epoxy adduct compounds can also be prepared at ambient conditions and the mixture must be allowed to sufficiently react for about 2 weeks at around 27° C. after mixing for about 3 to 5 hours.

In lieu of core-shell polymers, conventional tougheners such as epoxy adducted CTBN tougheners can be utilized as blended with either the above-noted tri-amine tougheners of the present invention or the above-noted epoxy adducted tri-amine tougheners. The CTBN tougheners are epoxy resin adducts of acid terminated butadiene-acrylonitrile copolymer and well known to the art and to the literature and described in prior art patents such as U.S. Pat. Nos. 3,966,837; 4,025,578; 4,107,116; 5,140,068; 5,198,510; 5,268,452; and 5,393,850, hereby fully incorporated by reference. Specific examples of such CTBN polymers include Hycar® 1300X13 or Hycar 1300X8. Epoxy adducted CTBN polymers are highly desirous as tougheners since the epoxy portion improves the solubility of the CTBN toughener within the epoxy resin. The amount of the CTBN polymer portion of the CTBN-epoxy adducted compound generally ranges from about 10% to about 60%, desirably from about 15% to about 50%, and preferably from about 25% to about 50% by weight. Hence, the difference constitutes the amount of epoxy adduct with in the CTBN-epoxy adduct compound. This compound is blended with either the above-noted tri-amine toughener, or the above-noted tri-amine-epoxy adduct compound. Thus, when a tri-amine-epoxy adduct compound is utilized, the total of 100 parts by weight of the epoxy resin is derived from the epoxy resin per se, the amount of epoxy resin contained within the tri-amine-epoxy adduct compound, as well as the epoxy contained within the CTBN-epoxy adduct compound. The amount of CTBN per se utilized per 100 total parts by weight of all the various different types of epoxy resins is generally from about 5 to about 30 parts by weight, desirably from about 10 to about 25 parts by weight and preferably from about 13 to about 18 parts by weight.

A blend of the epoxy adducted CTBN polymers with the tri-amine toughener, either epoxy adducted or not, has been found to yield good toughness when high levels of the two combined tougheners are utilized. This result was unexpected since normally it is not practical to use more than 15 parts by weight of a toughener before mechanical properties are compromised due to phasing transformations. However, with the present invention unexpectedly much higher amounts can be utilized. Thus as set forth above, preferred total amounts of both the tri-amine toughener and the CTBN toughener generally range from about 26 to about 36 parts by weight per 100 total parts by weight of the epoxy resins. Suitable blends of such tougheners are set forth in Table 2.

TABLE 2
Blends of Tri-amine and CTBN for Maximum Toughness

| | A | B |
|---|---|---|
| Epon 828 | 77.5 | 55 |
| 60/40 adduct of Epon 828/Hycar 1300X13 | 37.5 | 37.5 |
| Non-adducted Tri-amine | 15 | — |
| 60/40 adduct of Epalloy 8225*/Tri-amine | — | 37.5 |
| Level of Toughener (Parts) | 30 | 30 |

*Epalloy 8225 is a diglycidylether of bisphenol F

As noted above, another toughener of the present invention is an amine terminated tri-block polyether (tri-block) that desirably contains polyalkylene oxide blocks in any order containing repeat groups having a total of from 2 to 4 carbon atoms such as ABA or ABC or BAC, etc., block copolymers. Block copolymers containing polytetramethylene oxide and polypropylene oxide blocks are highly preferred and thus a preferred toughener generally has the formula amine-(PPO)(PTMO)(PPO)-amine where PPO contains polypropylene oxide repeat groups and PTMO contains polytretramethylene oxide repeat groups. Table 3 lists some of the commercial products and their compositions, found useful in this invention and include tri-blocks as well as the tri-amine.

TABLE 3

| Huntsman | |
|---|---|
| Additive | Composition |
| XTJ 410 | Terathane ®* 1000 plus about 2 moles of propylene oxide |
| XTJ 533 | Terathane 1000 plus about 6 moles of propylene oxide |
| XTJ 536 | Terathane 1000 plus about 17 moles of propylene oxide |
| XTJ 559 | Terathane 1000 plus 6 moles of propylene oxide |
| XTJ 542 | Terathane 650 plus 6 moles of propylene oxide |
| D 2000 | Di-primary amine functional polypropylene oxide |
| | 2000 Mol. Weight |
| T-3000 | Tri-primary amine functional polypropylene oxide |
| | 3000 Mol. Weight |
| T-5000 | Tri-primary amine functional polypropylene oxide |
| | 5000 Mol. Weight |

*Terethane ®, a trademark of Invista Corporation, represents polymers of polytetramethylene oxide (PTMO) that are di-hydroxy functional. In Table 1 the molecular weight of these PTMO varies from 650-1000. See US Patent 7,056,975 B2

The mole ratio of the (PPO) repeat groups to the (PTMO) repeat polyether groups is generally from 1 to about 20, desirably from about 2 to 16 preferably from about 2 to about 10 since lower amounts of end block (PPO) tend to give better results. The amine end group can generally be any of the amine compounds used to terminate the tri-amine terminated polyalkylene oxides as set forth hereinabove and hereby fully incorporated by reference. Desired amine end groups are primary amines. The total weight average molecular weight of the amine terminated tri-block polyether is from about 800 to about 2,000, desirably from about 1,000 to about 1,500, and preferably from about 1,000 to about 1,400. The performance of tri-block polymers is controlled by the molecular weight of the polytetramethylene oxide polymer and the amount of propylene oxide in the end blocks as noted above. As the percentage of propylene oxide increases the toughening properties of the tri-block are reduced in dicyandiamide cured epoxy resins. The best performing product was XTJ 410 which was slightly better than XTJ 542. The total amount of the amine terminated tri-block polyether polymers utilized is generally from about 5 to about 30 parts by weight, desirably from about 5 to about 25 parts by weight, and preferably from about 13 to about 18 parts by weight per every 100 parts by weight of the one or more liquid epoxy resins including any epoxy adducts on the tri-block or any other epoxy source.

As with the tri-amine terminated polyalkylene oxides, the amine terminated tri-block polyethers are desirably adducted with an epoxy since the same also yields improved solubility of the toughener in the epoxy resin and increased storage stability. The types of epoxies that can be utilized to adduct a tri-block polymer are the same as set forth hereinabove with respect to the tri-amine terminated polyalkylene oxide and are hereby fully incorporated by reference. A highly preferred epoxy resin is diglycidyl ether of bisphenol A (DGEBA) that has the following formula:

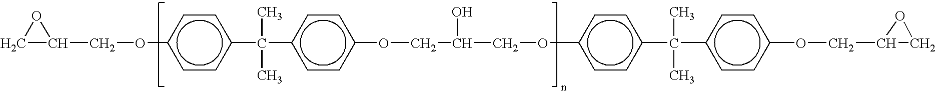

wherein n is from 0 or about 0.1 to about 5, desirably from 0 or about 0.1 to about 3.5, and preferably from 0 or about 0.1 to about 3.0. Other preferred epoxies include diglycidyl ethers of bisphenol F wherein n is less than 10. Epoxy resins particularly useful in this invention include lower viscosity resins other than a typical liquid DGEBA (EEW-190) resin. Di-functional aliphatic epoxies commonly considered as diluents in epoxy formulations include neopentyl glycol diglycidyl ether, 1,4-butanediol diglycidyl ether and cyclohexanedimethanol diglycidyl ether. If employed, such resins should be used judiciously to favorably affect viscosity but not at a level that would compromise mechanical properties.

The amount of amine terminated tri-block polymer in the tri-block epoxy adduct compound is about 10% to about 60%, desirably from about 15% to about 50%; and preferably from about 25% to about 50% by weight. In other words, the ratio of epoxide equivalents to amine hydrogen requirements must be maintained at about 3 to 1 or greater or desirably about 3.5 to 1 or greater to avoid high viscosity or gelation of these adducts (see Table 1).

The tri-block polyethers and their optional epoxy adducts are desirably utilized by combining them with either core-shell or epoxy adducts of acid terminated butadiene-acrylonitrile copolymers as set forth herein above, and hereby fully incorporated by reference. Although some improvement in properties is realized at levels of total toughener below 10 parts by weight, higher levels are required for materials and adhesives that possess high levels of toughness with excellent low temperature properties and some resistance to higher speed impacts. As noted above, heretofore, it generally was not practical to use more than 15 parts of epoxidized Hycar CTBN toughener before mechanical properties are compromised due to phasing transformations. However, with the present higher amount unexpectedly still yield improved properties. For example, a blend of about 25 to 35 parts of a 1/1 ratio of T-3000 neat or adducted/Hycar 1300X13 as an adduct provides an unexpected increase in the level of toughness with only a moderate decrease in Tg. The same is true of blends of 1/1 core-shell/tri-block blends used at preferred levels of about 25 to 35 parts except the Tg is slightly better due to the presence of core-shell particles.

Generally, the amount of the core-shell polymers utilized with the tri-block polymers is from about 5 to about 30, desirably from about 10 to about 30, and preferably from about 15 to about 25 parts by weight per 100 total parts by weight of all epoxy resins. The amount of the butadiene-acrylonitrile copolymers (CTBN) is per se generally from about 5 to about 30, desirably from about 10 to about 25, and preferably from about 13 to about 18 parts by weight per 100 total parts by weight of all epoxy resins. The amount of the CTBN per se within the CTBN-epoxy adduct compound is generally from about 10% to about 60%, desirably from about 15% to about 50%, and preferably from about 25% to about 50% by weight.

The liquid di-amine terminated polyether tougheners are derived from alkylene oxides containing a total number of from 2 to 4 carbon atoms such as ethylene oxide, propylene oxide, or butylene oxide, or combinations thereof with propylene oxide being highly preferred. The di-amine terminated polyether is generally prepared by reacting alkylene oxide with a diol initiator followed by amination of the terminal hydroxide groups. The toughener thus contains two separate amine end groups. The preferred terminal amine group is preferably a primary amine, i.e. —NH₂ although other amines can be utilized such as secondary amines. The weight average molecular weight of the various di-amine terminated polyethers is generally from about 1,000 to about 3,000, desirably from about 1,500 to about 2,500, and preferably from about 1,800 to about 2,200. Jeffamine D 2000 from Huntsman is representative of this type of diamine product.

The amount of the di-amine terminated polyalkylene oxide tougheners of the present invention when used as a sole toughener generally range from about 5 to about 30 parts by weight, desirably from about 5 to about 25 parts by weight, and preferably from about 13 to about 18 parts by weight per every 100 parts by weight of the one or more above-noted epoxy resins as well as the hereinbelow adducted epoxy resins when present, or any other epoxy source.

As noted above, high molecular weight di-amine terminated polyalkylene oxide tougheners having a molecular weight of greater than 3,200 are avoided inasmuch as they do not yield comparable properties as does the low molecular weight di-amine terminated polyalkylene oxides. If the high molecular weight di-amine terminated tougheners are utilized, they are utilized in low amounts as set forth hereinabove and fully incorporated by reference.

As with the tri-amine terminated polyalkylene oxide tougheners, the di-amine terminated polyalkylene oxide tougheners can be utilized “as is” with the various above-noted one or more epoxy resins. However, it is highly desirable to adduct the di-amine terminated toughener with epoxy resin to improve the solubility of the toughener in the epoxy resin and also the stability of the viscosity of compounded epoxy resins when aged at ambient conditions prior to bonding because the adduct no longer contains active amine hydrogens. The types of epoxies that can be adducted onto the di-amine terminated polyalkylene oxide tougheners are the same as set forth hereinabove with respect to the tri-amine terminated polyalkylene oxide tougheners and are hereby fully incorporated by reference. The adducted di-amine terminated tougheners have low viscosities and thus they are readily incorporated into one or more various epoxy compounds. Preferred adducting epoxy resins include the diglycidyl ethers of bisphenol A (DGEBA) and bisphenol F (DGEBF). Bisphenol F is generally preferred if a lower viscosity is to be achieved. Lower viscosity epoxies such as neopentyl glycol diglycidyl ether, 1,4-butane diol diglycidyl ether, cyclohexanedimethanol diglycidyl ether and other low viscosity difunctional epoxies may be added in amounts less than 20 parts based on 100 parts of either DGEBA or DGEBF or combinations of DGEBA and DGEBF to lower the viscosity of di-amine adducts. The ratio of epoxy resin to di-amine toughener in preparing the adducts is selected to provide a ratio of epoxy equivalents to amine equivalents of greater than about 2.8 to 1 and desirably about 4 to 1 or greater. A significant excess of epoxide equivalents must be present in order to avoid high viscosity or gelation of these adducts.

The amount of the di-amine compound in the di-amine-epoxy adduct compound is generally from about 10% to about 60%, desirably from about 15% to about 50%, and preferably from about 25% to about 50% by weight based upon the total weight of the di-amine-epoxy adduct compound. The di-amine toughener-epoxy composition can contain all of the di-amine toughener as containing epoxy adducts thereon, or can contain only di-amine polyalkylene oxide tougheners, or blends of the same. In all situations, the total amount of the di-amine terminated polyalkylene oxide toughener per se is within the above noted range of from about 5% to about 30% by weight based upon 100 total parts by weight of epoxy resin wherein the composition contains only epoxy resin per se, adducted epoxy resin, combinations of the two, or even contain additional other epoxy resins.

The adduction of an epoxy onto the di-amine terminated polyalkylene oxide toughener generally involves mixing the di-amine terminated toughener with an epoxy resin and reacting at a temperature of about 25° C. for two weeks or about 100° C. for four hours. Preferred reaction conditions are from about 4 to about 10 hours at about 80° C.

The di-amine terminated polyalkylene oxide tougheners of the present invention, whether or not adducted, can be blended with various core-shell polymers. Based upon 100 total parts by weight of epoxy regardless of the source of epoxy, the amount of the shell-core polymer is generally from about 5 to about 30 parts by weight, desirably from about 10 to about 30 parts by weight, and preferably from about 15 to about 25 parts by weight. Such amounts are generally limited by the viscosity and for lower viscosities, as noted, the epoxy desirably is either a liquid diglycidyl ether of bisphenol A, a liquid diglycidyl ether of bisphenol F, or mixtures thereof.

The description of the shell-core polymers such as with respect to the chemical composition, Tg, and the like, is essentially that as set forth hereinabove with regard to the tri-amine terminated polyalkylene oxide polymers and thus will not be repeated but rather is fully incorporated by reference. Thus, blends of the di-amine toughener and the core-shell polymers can be used at high levels of both tougheners, i.e. about 15 parts by weight of core-shell and 15 parts by weight of di-amine per 100 total parts of all epoxies in the blend. As with the tri-amine terminated polyalkylene oxide tougheners, blends of the core-shell compounds are best achieved by utilizing the epoxy adducts of the di-amine terminated polyalkylene oxide tougheners.

In lieu of core-shell polymer tougheners, other conventional tougheners can be utilized such as epoxy adducted CTBN tougheners and the same are blended with either epoxy adducted or non-epoxy-adducted di-amine polyalkylene oxide tougheners. The composition of the various CTBN tougheners, the amount of the CTBN polymer portion of the CTBN-epoxy adducted toughener, and the like is the same as set forth hereinabove and hence will not be repeated but is hereby fully incorporated by reference. When utilized, the amount of the CTBN tougheners is generally from about 5 to about 30 parts by weight, desirably from about 10 to about 25 parts by weight, and preferably from about 13 to about 18 parts by weight per 100 total parts by weight of the all the various different types of epoxy resins that are utilized in the epoxy toughened compositions. The amount of the CTBN in the CTBN-epoxy adduct is from about 10% to about 60%, desirably from about 15% to about 50%, and preferably from about 25% to about 50% by weight based upon the total weight of the CTBN-epoxy adduct.

An important aspect of the present invention is that before cure of the tri-amine terminated polyalkylene oxide toughener, the di-amine terminated polyalkylene oxide toughener, and the amine terminated polyalkylene oxide tri-block toughener, each per se or adducted with epoxy, when added to most liquid epoxy resins in the above indicated amounts yield excellent toughness without the use of higher molecular weight epoxy resins or polymers. As a result lower viscosity paste products can be formulated. When adducted with an epoxy, these tougheners generally result in an epoxy resin composition having a viscosity of about 500,000 centipose or less, desirably about 300,000 centipose or less; and preferably from about 60,000 or about 100,000 to about 200,000 or about 300,000 centipose, all at a temperature of 27° C. These viscosity levels are generally lower than solutions containing the same epoxy resin with traditional tougheners such as carboxyl terminated copolymers of butadiene and acrylonitrile. Typical viscosities of the various forms of this toughening technology are set forth in Table 1.

Low molecular weight di-primary amine functionalized tri-block amines such as XTJ 542 are most conveniently used in an non-adducted or low amounts of the adducted form since at practical levels such as greater than 40% by weight of adducted toughener they have very high viscosities (see XTJ 542 adduct in Table 4).

Preparation of Adhesives and Adhesive Lay-Up

A typical epoxy based adhesive is prepared by mixing solid ingredients into the liquid ingredients at ambient conditions generally around 25°-30° C. using a mixing device such as a Hobart® mixer. Alternately, solid curatives may be mixed with a portion of the epoxy resin utilizing a three roll mill. After all ingredients are combined a vacuum is applied to remove air. Typically these types of adhesives and materials are cured utilizing accelerated dicyandiamide curing. An example of a model adhesive used in the work contained in this application is shown below.

TABLE 4
Model Adhesive Formulations

| Ingredient | Parts |
|---|---|
| Liquid Epoxy Resin (about 400 Molecular Weight) Epon ® 828*, Epalloy ® | 100 |
| 8225** ^{or} | |
| Tri-primary amine terminated polypropylene oxide polymer for instance T- | 0-15 |
| 3000 ® (Huntsman Corp) as is or adducted | |
| Tri-block Polyether such as XTJ 542 (Huntsman Corp.) as is or adducted | 0-15 |
| Core-Shell such as Paraloid EXL ® 2691A, and 2330 (Rohm and Haas) | 0-15 |
| Di-primary amine terminated polypropylene oxide polymer for instance D | 0-15 |
| 2000 (Huntsman Corp.) as is or adducted | |
| Hycar ® CTBN Adducted such as 1300X13 or X 8*** Epon 58005 and Epon | 0-15 |
| 58006 (Resolution) | |
| Filler (Tabular Alumina T-60 325 mesh) (Alcoa Aluminum) | 0-80 |
| Dicyandiamide (Amicure ® CG 1400) Air Products | 1-6 |
| Amicure UR ®***, Omicure ® U-405**** Accelerators | 0.2-3 |
| Cab-O-Sil ® TS 720 Flow Control Cabot Corp | 1-4 |

*Resolution
**CVC Corp.
***Air Products
****CVC

With respect to procedure, most of the bonding was done using clean acetone wiped electro-galvanized steel EZ 60 obtained from ACT Test Panels, 273 Industrial Drive, Hillsdale, M149242. Bond-lines were controlled at 0.25 mm (10 mils) by placing 0.25 mm diameter glass beads in the bond-lines. Individual test coupons were held together for curing by using ¾ inch binder clips. After curing at 177° C. for 30 minutes the above examples were tested with regard to peel strength at room temperature, at minus 40° C., and also with respect to lap shear at 90° C. The T-Peel test is in accordance with ASTM D-1876 wherein T-peel specimens were bonded over 3 inches (7.6 cm) instead of 9 inches (22.9 cm). In addition, 1 inch tabs (2.54 cm) instead of 3 inch (7.6 cm) were used for gripping in the Instron Tester. With regard to the Lap-shear test, results were obtained in accordance with ASTM D-1002 wherein the procedure was modified to use 2.54×10.2 cm coupons. Actual bonded area was 2.54 cm×76.2 cm. Coupons were 80 mils (2 mm) thick. Individual specimens were made as opposed to making larger specimens and cutting them as described in the ASTM procedures. Overlaps of 2.54 cm were used for lap shear testing.

Once the various components including one or more of the above noted tougheners of the present invention, whether or not adducted with an epoxy, are mixed with various additives and one or more epoxy resins, they are generally paste-like materials which are easily applied at ambient conditions by extrusion or other methods and are used to bond metals, as described above. Curing agents such as amine curing agents, e.g. dicyandiamide, are generally utilized in an amount of from about 2 to about 10 parts, desirably 3 to about 8, and preferably 4 to about 6 parts by weight per 100 parts by weight of the epoxy resin. Polyamines are a very common curing agent and include primary and secondary amines with examples including diethylene tri-amine, triethylene tetramine, 4,4′-diaminodiphenolmethane as well as various polyaminoamides. Other suitable curatives known to the art and to the literature for curing epoxy resins can also be used. However, the tougheners of the present invention perform best with dicyandiamide (cyanoguanidine and derivatives), which is the highly preferred curing agent.

Accelerators are generally utilized to speed up the cure rate and a desired class are various urea compounds, especially tri-substituted ureas. Representative urea compounds include phenyl dimethyl urea, toluene bis-dimethyl urea, 2,4-toluene bis-dimethyl urea, methylene bis-(phenyl dimethyl urea), 4,4′-methylene bis-(phenyl dimethyl urea), cycloaliphatic bis-urea, and other amine functional species such as 2-ethyl-4-methylimidazole, 3,3′-diaminodiphenyl sulphone, and boron tri-chloride amine adduct. Amicure® UR and Omicure® (1,1 dimethyl-3 phenyl urea) are preferred but all substituted ureas generally perform adequately. These dicyandiamide accelerators are available under the tradename AMICURE® and are available from Air Products Company of Pennsylvania. Omicure® is available from CVC Corporation of New Jersey. The amount of such accelerators can vary from about 0.1 to about 8 parts with from about 1 to about 3 parts by weight being preferred for every 100 parts by weight of the epoxy resin. Weak bases can also be used such as tri-ethanol amine, n-butylamine, and tri-phenylphosphine. However, the tri-substituted ureas offer the best combination of properties and storage stability.

Various other additives can be used such as colorants, fillers, anti-oxidizing agents, foaming agents, chain extenders such as bisphenol A and 1,5 napthalene diol; higher molecular weight epoxy resins and flow control agents in conventional amounts as known to the art and to the literature.

Fillers are generally used in adhesives to reduce cost or to affect some particular property. As the levels of common fillers such as silicates and CaCO₃ are increased, peel properties and toughness are usually reduced. The filler used in the model adhesives of the present invention was Tabular Alumina T-60 from Alcoa Aluminum. This filler does not generally reduce peel properties at levels around 30% to 40%. In fact with some toughened adhesives peel properties may be slightly enhanced when using Tabular Alumina T-60 at the levels shown above. This is especially true when evaluating low temperature peel properties where in many cases peel strength is actually improved. Also, peel values are usually more uniform from test to test when using tabular alumina. Fillers such as Tabular Alumina perform adequately when bonding aluminum adherends and galvanized steel. However, moisture resistance and corrosion resistance were not determined for adhesives containing this Tabular Alumina.

The cured toughened epoxy resin compositions of the present invention have unexpected improved properties such as high peel strength at temperatures from about minus 20° C. to about minus 65° C. Generally, T-peel strengths at minus 40° C. according to ASTM D-1876 are at least about 160 or at least about 175, preferably at least about 225 up to about 275 or about 325 Newtons per 25 millimeters. Improved properties are also obtained with regard to high speed impact properties as measured by ISO 11343.

The invention will be better understood by reference to the following Examples which serve to illustrate, but not to limit the present invention. Generally Examples 1 through 10 relate to the utilization of tri-amine terminated polyalkylene oxide tougheners per se or epoxy adducted and/or amine terminated triblock polyether tougheners per se or epoxy adducted.

### EXAMPLES

### Example 1

The core-shell polymers were obtained from Rohm and Haas Company and contain a core derived from butadiene and styrene monomers and a shell derived from methyl methacrylate monomers. Epon 828 was purchased from Resolution and T-3000 and XTJ 542 were obtained from Huntsman Corporation. The formulation of tougheners is set forth in Table 5 wherein blends A and C contain adducted epoxy tougheners. The toughener adducts were generally made in a similar manner. For example, with regard to toughener B (Table 5) a 25% core-shell dispersion was prepared in bisphenol F epoxy resin by mixing at ambient conditions for about 3 hours with moderate to high shear. Toughener A is 80 parts by weight of the core-shell dispersion (Toughener B) mixed with 20 parts by weight of T-3000 and heated for 8 hours at 80° C. with occasional stirring. The resultant product is 60% epoxy resin and 40% toughener. The toughener portion is 50% core-shell and 50% T-3000. Toughener C was prepared by mixing ingredients and reacting at 80° C. for 16 hours with occasional stirring.

TABLE 5

| | Parts by | | |
|---|---|---|---|
| | weight | | |
| Toughener Adducts and Blends | A | B | C |
| Epalloy 8225 (bis F diepoxyide purchased from CVC) | 60 | 75 | 60 |
| BA 509 (T-3000) (obtained from Huntsman Corp.) | 20 | — | 40 |
| (epoxy adducted) | | | |
| Paraloid EXL ™ 2691A (core-shell purchased from | 20 | 25 | — |
| Rohm & Haas Corp.) | | | |

The above toughener adducts and blends as well as other toughener forms were mixed with an epoxy resin and other components including a curing agent and an accelerator as set forth in Table 4 and tested with respect to various properties. Materials are mixed as described earlier (Adhesive Preparation).

The recipes with regard to adhesives 1-8 are as follows.

TABLE 6

| Ingredients | 1 | 2 | 3 | 4 | 5 | 6 | 7 | 8 |
|---|---|---|---|---|---|---|---|---|
| Epon 828 | 77.5 | 55 | 55 | 55 | 77.5 | 55 | 77.5 | 55 |
| Blend Adduct A | 37.5 | 75 | — | — | — | — | — | — |
| (Table 6) | | | | | | | | |
| Blend B (Table 6) | — | — | 60 | 60 | — | — | — | — |
| Adduct C (Table 6) | — | — | — | — | 37.5 | 75 | — | 37.5 |
| Epon 58005 | — | — | — | — | — | — | 37.5 | 37.5 |
| (Epon 828 - 60% | | | | | | | | |
| by weight) | | | | | | | | |
| (CTBN - 40% by | | | | | | | | |
| weight) | | | | | | | | |
| BA 509 (T-3000) | — | — | — | 15 | — | — | — | — |
| Tri-amine | | | | | | | | |
| Tab Aluminum | 40 | 40 | 40 | 40 | 40 | 40 | 40 | 40 |
| Dicy CG 1400 | 5 | 5 | 5 | 5 | 5 | 5 | 5 | 5 |
| (dicyandiamide | | | | | | | | |
| curing agent) | | | | | | | | |
| Amicure ® UR | 2 | 2 | 2 | 2 | 2 | 2 | 2 | 2 |
| (accelerator) | | | | | | | | |
| 1,1 dimethyl 3 | | | | | | | | |
| phenyl urea | | | | | | | | |
| Cab-O-Sil ® TS 720 | 3 | 3 | 3 | 3 | 3 | 3 | 3 | 3 |
| Total Pts of Core-shell | 7.5 | 15 | 15 | 15 | 0 | 0 | 0 | 0 |
| (EXL 2691) | | | | | | | | |
| Total Pts of T-3000 | 7.5 | 15 | 0 | 15* | 15 | 30 | 0 | 15 |
| (epoxy adducted) | | | | | | | | |
| Total Pts of Hycar ® | 0 | 0 | 0 | 0 | 0 | 0 | 15 | 15 |
| 1300X13 | | | | | | | | |
| from Epon 58005 | | | | | | | | |
| (CTBN) | | | | | | | | |

*Non-adducted T-3000

Test results are set forth in Table 7.

TABLE 7

| | Cured Adhesives | | | | | | | |
|---|---|---|---|---|---|---|---|---|
| | 1 | 2 | 3 | 4 | 5 | 6 | 7 | 8 |
| T-peel @ −40° C. N/25 mm | 202 | 330 | 159 | 315 | 202 | 252 | 70.5 | 320 |
| T-peel @ RT N/25 mm | 237 | 277 | 252 | 258 | 202 | 222 | 188 | 252 |
| Lap Shear @ 90° C. Mpa | 6.97 | 6.73 | 7.03 | 7.31 | 6.63 | 4.84 | 7.24 | 7.03 |

As apparent from Table 7, Adhesive 1 reveals that the combination of Core Shell and tri-amine is superior to 15 parts of Core-shell (Adhesive 3) or 15 parts of Hycar 1300X13, Adhesive 7. Adhesive 2 shows that the utilization of approximately 15 parts by weight each of a core-shell polymer and a tri-amine terminated polyalkylene oxide toughener according to the present invention yield an excellent minus 40° C. low temperature peel result of 330 N/25 mm. Control adhesives, Adhesive 3, toughened with 15 parts of core-shell and Adhesives 7, toughened with 15 parts of CTBN, are lower in peel strength than Adhesive 2. Adhesive 4 shows that when a non-adducted tri-amine terminated polyalkylene oxide toughener was utilized in association with a core-shell toughener, an improvement of almost 100%, a low temperature peel strength of 315 N/25 mm was obtained. Adhesive 6 shows that the utilization of a tri-amine terminated polyalkylene oxide toughener by itself yielded good low temperature peel strength of approximately 252 N/25 mm. Adhesive 8 shows that an increase of at least a factor of 4, a peel strength of 320 N/25 mm, was obtained when the 15 parts of adducted tri-amine terminated polyalkylene oxide toughener was added to 15 parts of adducted Hycar 1300X13. Adhesives 4 and 8 each contain 30 parts of toughener yet retain the lap shear strength at 90° C.

### Example 2

The amine terminated tri-block polymer was used along with an adduct of Hycar 1300X13. The amount of the tri-block polymer (XTJ 542) was varied and the concentration of Hycar 1300X13 was maintained at 15 parts.

TABLE 8
Base Formulation

| | |
|---|---|
| Epon 828 | 100 |
| 1300X13* (CTBN) | 15 |
| XTJ 542 (tri-block) | Variable |
| Dicy Amicure CG 1400 | 5 |
| Amicure UR | 2 |
| Tabular Alumina | 40 |
| TS 720 | 3 |

*Added as an adduct

Electro-galvanized G-60 steel bonded, 10 mil bond lines cured 30 minutes@ 177° C.

TABLE 9
Results

| Ingredient | 1 | 2 | 3 | 4 | 5 |
|---|---|---|---|---|---|
| Tabular Alumina | 0 | 0 | 0 | 0 | 40 |
| 1300X13* CTBN | 15 | 15 | 15 | 15 | 15 |
| XTJ 542** (tri-block) | 0 | 5 | 10 | 15 | 15 |
| T-peel @ −40° C. | 76 | 80 | 166 | 231 | 305 |
| N/25 mm | | | | | |
| T-peel @ RT N/25 mm | 193 | 194 | 222 | 247 | 277 |
| Lap shear @ 90° C. | 6.74 | 6.43 | 5.84 | 4.81 | 5.46 |
| Mpa | | | | | |

*40% Hycar 1300 X 13 in Epon 828
**Tri-block (See Table 1)

The low temperature peel strength is not increased until about 10 parts of tri-block, XTJ 542 are added to an adhesive which already contains 15 parts of Hycar 1300X13 (compare adhesive 1 with adhesives 2 and 3). At the 10 part level the low temperature peel doubles and is about three times higher when 15 parts of XTJ 542 are added to Adhesive 4. In this case the level of toughness was further enhanced by the filler Tabular Alumina (compare Adhesive 4 with Adhesive 5).

### Example 3

The ratios and levels of non-adducted XTJ 542 (Table 1) (tri-block) and Hycar 1300x13 (CTBN) were varied as shown in Tables 10 and 11.

TABLE 10
Base Formulation

| | |
|---|---|
| Epon 828 | 100 |
| 1300X13* (CTBN) | Variable |
| XTJ 542 (tri-block) | Variable |
| Dicy | 5 |
| Amicure UR | 2 |
| Tabular Alumina | 40 |
| TS 720 | 3 |

TABLE 11
Results

| | Tougheners | | | | | | |
|---|---|---|---|---|---|---|---|
| | A | B | C | D | E | F | G |
| XTJ 542 non-adducted) (tri-block) | 15 | 10 | 7.5 | 15 | 5 | 0 | 15 |
| Hycar 1300X13 Adduct* | 15 | 10 | 7.5 | 5 | 15 | 15 | 0 |
| T-Peel N/25 mm at 27° C. | 247 | 157 | 106 | 110 | 221 | 166 | 75 |
| T-Peel N/25 mm at −40° C. | 225 | 103 | 70 | 55 | 155 | 125 | 49 |
| Lap Shear Mpa at 90° C. | 5.34 | 6.03 | 7.03 | 6.21 | 6.27 | 7.24 | 7.10 |

*Epon 58005

The adhesives in Tables 10 and 11 show that the maximum toughness is attained with 15 parts of each toughener (compare Adhesive A to Adhesives B through G that contain low amounts of adduct and/or toughener. In fact un-adducted XTJ 542 is only moderately effective as the sole toughener (Adhesive G).

### Example 4

The effect of the ratio and level of tri-block Adduct (2/1 Epon 828/XTJ 533) when added to Hycar 1300X13 (CTBN) adducts (Epon 58005), on properties of Adhesives was determined and shown in Table 12.

TABLE 12
Adhesives and Results

| | A | B | C | D | E | F |
|---|---|---|---|---|---|---|
| Epon 828 | 82.5 | 73.8 | 72.5 | 75 | 77.5 | 70 |
| Epon 58005 | 12.5 | 18.7 | 12.5 | 25 | 37.5 | — |
| 2/1 adduct of | 15 | 22.5 | 30 | 15 | — | 45 |
| Epon828/ | | | | | | |
| XTJ 533 | | | | | | |
| Tabular Alumina | 40 | 40 | 40 | 40 | 40 | 40 |
| Dicy | 5 | 5 | 5 | 5 | 5 | 5 |
| Amicure UR | 2 | 2 | 2 | 2 | 2 | 2 |
| TS 720 | 3 | 3 | 3 | 3 | 3 | 3 |
| Parts of 58005 | 5 | 7.4 | 15 | 10 | 15 | — |
| Parts of XTJ 533 | 5 | 7.4 | 10 | 5 | — | 15 |
| (tri-block) | | | | | | |
| Total Parts | 10 | 14.8 | 15 | 15 | 15 | 15 |
| toughener | | | | | | |
| Results | | | | | | |
| T-peel @ RT N/25 | 188.5 | 233 | 232 | 202 | 199 | 224 |
| mm | | | | | | |
| T-peel @ −40° C. | 50 | 82 | 106 | 75 | 78 | 195 |
| N/25 mm | | | | | | |
| Lap Shear @ | 7.17 | 6.9 | 6.97 | 7.03 | 7.17 | 6.9 |
| −40° C. Mpa | | | | | | |

These data indicate that XTJ 533 adducts are effective tougheners with RT peel equivalent to 58005 and with −40° C. peel that is improved when compared to Hycar 1300X13 adducts (compare E with F in Table 12). Also note that the combination of 58005 and the 33% adduct of XTJ 533 do not reach the level of toughness at low temperatures when a total of 15 parts of toughener is used. To obtain a formulation that has optimum toughness and therefore improved high-speed impact resistance, the concentration should be around 15 parts of each toughener (Hycar 1300X13 and Tri-block as shown previously in Table 11, Adhesive A.).

### Example 5

### Effect of XTJ 542 (tri-block) with Hycar 1300X8 (CTBN)

In this Example a comparison of 1300X8 and X13 will be evaluated in one-part adhesives. The first evaluations were done using Epon 58805 and 58006 and adding 15 parts of XTJ 542 to each system using our Standard Base One-part Adhesive.

TABLE 13
Standard Base Adhesive

| | |
|---|---|
| Epon 828 | 77.5 |
| Epon 58005 or 58006 | 37.5 |
| Tabular Alumina | 40 |
| Dicy | 5 |
| Amicure UR | 2 |
| TS 720 | 3 |
| XTJ 542 Tri-block (Table 1) | 15 |

*Epoxy adducts 40% CTBN

The results are shown in Table 14

TABLE 14
Results

| | CTBN co- | −40° C. T-peel | RT T-peel | Lap shear @ |
|---|---|---|---|---|
| Ref | toughener | N/25 mm | N/25 mm | 90° C. Mpa |
| A 2 | 1300X8 | 232 | 252 | 5.50 |
| B 2 | 1300X13 | 310 | 260 | 5.10 |
| A 30 | 1300X8 | 262 | 255 | 5.72 |
| B 30 | 1300X13 | 292 | 317 | 5.18 |

A2 and B2 aged 2 days at RT before bonding
A30 and B30 aged 30 days at RT before bonding

Both Hycar 1300X13 and Hycar 1300X8 had good initial peel values at −40° C. Adhesives A2 and B2 with Hycar 1300X13 being better, 232 versus 310 N.25 mm. After aging these adhesives for 30 days at about 27° C. the peel properties were essentially unchanged.

### Example 6

With dicyandiamde curing epoxy resin based adhesives, tri-amine T-3000, works well while the higher molecular weight T-5000, weight average molecular weight of 5,000, is less effective as a toughener. Three adducts were prepared to study the effect of blends of T-3000 adducts with T-5000 adducts. Adhesives were prepared as shown in Table 15 by blending T-3000 adducts with T-5000 adducts.

TABLE 15
Adhesives

| Ingredient | A | B | C | E | F |
|---|---|---|---|---|---|
| Epon 828 | 70 | 70 | 70 | 70 | 70 |
| ½ T-3000/Epon 828* | 45 | 34 | 22.5 | 11 | — |
| ½ T-5000/Epon 828* | — | 11 | 22.5 | 34 | 45 |
| Tabular Alumina | 40 | 40 | 40 | 40 | 40 |
| Dicy | 5 | 5 | 5 | 5 | 5 |
| Amicure UR | 2 | 2 | 2 | 2 | 2 |
| TS 720 | 3 | 3 | 3 | 3 | 3 |

*Adducts

Clean EZ 60 10 mil bond-lines cure at 177° C. for 300 minutes

TABLE 16
Results

| | A | B | C | D | E |
|---|---|---|---|---|---|
| T-peel @−40° C. N/25 mm | 169 | 168 | 110 | 87 | 87 |
| T-peel @ RT N/25 mm | 173 | 177 | 128 | 92 | 96 |
| Lap Shear @90° C. Mpa | 6.84 | 6.9 | 6.81 | 6.57 | 6.46 |
| Parts of T-3000 | 15 | 11.4 | 7.5 | 3.6 | 0 |
| Parts of T-5000 | 0 | 3.6 | 7.5 | 11.4 | 15 |

As T-5000 adduct is added to the XTJ 533 adduct the peel strength slowly decreases except for B in Table 16.

### Example 7

Two adhesives were prepared to evaluate the stability when using non-adducted T-3000 (tri-amine) and XTJ 533 (tri-block) in adhesives as the sole toughener.

TABLE 17
Adhesives

| | A | B |
|---|---|---|
| Epon 828 | 100 | 100 |
| Tabular Alumina | 40 | 40 |
| Dicy | 5 | 5 |
| Amicure UR | 2 | 2 |
| Cab-O-Sil TS 720 | 3 | 3 |
| T-3000 (tri-amine) | — | 15 |
| XTJ 533 (tri-block) | 15 | — |

Epoxy resins, curatives and thixotrope were mixed on an ink mill and the tabular alumina and toughener added and mixed under vacuum for 20 minutes. After 1 day; 1, 2 and 3 weeks; 1 month and 2 months the adhesives were used to bond clean EZ 60, 10 mils thick and cured 30 minutes at 177° C. Results are shown in Table 18.

TABLE 18
Results

| | T-peel @ −40° C. | T-peel @RT | Lap shear @90 C. |
|---|---|---|---|
| | N/mm | N/mm | Mpa |
| A 1 day | 172 | 160 | 6.35 |
| B 1 day | 140 | 157 | 6.37 |
| A 1 weeks | 178 | 175 | 6.70 |
| B 1 weeks | 120 | 178 | 6.79 |
| A 2 months | 181 | 169 | 6.81 |
| B 2 months | 152 | 136 | 6.87 |

Initial adhesive peel properties were lower than those obtained with the corresponding adducts and did not decrease significantly after 2 months aging at about 27° C. before curing. However the viscosity of the adhesives had continued to increase.

### Example 8

Impact Wedge Peel Strength was determined on two adhesives. The formulations are shown in Table 20. Adhesive A was toughened with 15 parts of a core-shell polymer Paraloid EXL™ 2330 from Rohm and Haas and also contained 15 parts of non-adducted XTJ 410 tri-block from Huntsman (Table 1). Adhesive B was toughened with 15 parts of RLP (Hycar 1300x13 as an adduct 58005) and also contained 15 parts of XTJ 410.

TABLE 19
Adhesives

| | A | B |
|---|---|---|
| Epon 828 | 100 | 100* |
| Paraloid EXL ™ 2330** | 15 | — |
| Hycar 1300 X 13** (CTBN) | — | 15 |
| XTJ 410 (tri-block) | 15 | 15 |
| Tabular Alumina | 40 | 40 |
| Dicyandiamide | 5 | 5 |
| Amicure UR | 2 | 2 |
| Cab-O-Sil TS 720 | 3.5 | 3.5 |

*22.5 parts of epoxy resin is from Epon 58005
**Obtained from Rohm and Haas Corp.
***Epon 58005 obtained from Resolution is 40% toughener in epoxy resin.

Therefore, 37.5 parts of Epon 58005 contains 15 parts of Hycar 1300X13

TABLE 20
Results

| Test | A | B |
|---|---|---|
| G_{ic}*J/m² | 2233 | 2331 |
| Impact Wedge Peel**, N | 599 | 760 |
| Tg° C., DSC | 95 | 87 |

*ASTM D-5045
**ISO 11343

Both base tougheners, Paraloid 2330 and Hycar 1300X13 performed well in the impact Wedge Peel Test when XTJ 410 was added at a level of 15 parts. However, the combination of Hycar 1300X13 and XTJ 410 was about 25% better in Impact Wedge Peel strength.

### Example 9

An adduct of T-3000 and Epon 828 (40% T-3000, was prepared at 80° C. The viscosity was 212,000 cps at 27° C. Adhesives were prepared as shown in Table 21 to evaluate the aging properties of adhesives containing T-3000 as an adduct and comparing the properties with an adhesive toughened with Epon 58005 (Hycar 1300X13).

TABLE 21

| | A | B |
|---|---|---|
| Epon 828 | 77.5 | 77.5 |
| 60/40 adduct of Epon 828/T-3000 (tri-amine) | 37.5 | |
| Epon 58005 | | 37.5 |
| Tabular Alumina | 40 | 40 |
| Dicy | 5 | 5 |
| Amicure UR/710 | 2 | 2 |
| TS720 | 3 | 3 |

* Adduct Epon ® 58005

Adhesives were aged at room conditions before bonding. Results are in Table 22.

TABLE 22

| Age* | | A | B |
|---|---|---|---|
| 1 day** | T-peel @ −40° C. N/25 mm | 230 | 109 |
| 1 day | T-peel @ RT N/25 mm | 220 | 211 |
| 1 day | Lap Shear @ 90° C. Mpa | 6.97 | 6.83 |
| 6 weeks | T-peel @ −40° C. N/25 mm | 250 | 96 |
| 6 weeks | T-peel @ RT N/25 mm | 241 | 200 |
| 6 weeks | Lap Shear @ 90° C. Mpa | 6.49 | 6.97 |
| 6 months | T-peel @ −40° C. N/25 mm | 275 | 101 |
| 6 months | T-peel @ RT N/25 mm | 257 | 234 |
| 6 months | Lap Shear @ 90° C. Mpa | 7.45 | 7.31 |
| Parts of T3000 | | 15 | — |
| (tri-block) | | | |
| Parts of Hycar | | — | 15 |
| 1300X13 (CTBN) | | | |

*Age before bonding at about 25° C.
**Sample designation. Epon 58005
Clean EZ 60 Cured 30 minutes at 177° C.

Generally much better results were obtained using the tri-amine toughener as compared to the prior art CTBN toughener.

### Example 10

An adduct of T-3000 and Hycar 1300X13 with Epon 828 and Epalloy 8225 was prepared. The adduct was 30 parts on Epon 828; 30 parts of Epalloy 8225, 20 parts of T-3000 and 20 parts of Hycar 1300X13. It was prepared by reacting epoxy resins with Hycar 300X13 for three hours at 120° C. After cooling T-3000 was added and reacted at 85° C. for 5 hours.

TABLE 23
Adduct Composition

| | Parts |
|---|---|
| Epon 828 | 30 |
| Epalloy 8225 | 30 |
| Hycar 1300X13 | 20 |
| T-3000 | 20 |

The following formulations were made and tested.

TABLE 24
Formulations and Results

| | A | B | C | D | E |
|---|---|---|---|---|---|
| Epon 828 | 92.5 | 85 | 77.5 | 66.3 | 55 |
| Adduct of Table 23 | 12.5 | 25 | 37.5 | 56.2 | 75 |
| Tabular Alumina | 40 | 40 | 40 | 40 | 40 |
| Dicy | 5 | 5 | 5 | 5 | 5 |
| Amicure UR | 2 | 2 | 2 | 2 | 2 |
| TS 720 | 3 | 3 | 3 | 3 | 3 |
| Parts of adduction | 5 | 10 | 15 | 22.5 | 30 |
| Toughener (Table 23) | | | | | |
| T-peel @ RT N/mm | 101 | 182 | 223 | 250 | 235 |
| T-peel @ −40° C. | 39 | 46 | 122 | 252 | 300 |
| N/mm | | | | | |
| Lap shear @ 90° C. PSI | 7.51 | 7.65 | 7.58 | 7.58 | 7.17 |

Excellent toughness was obtained at 22.5 parts of this toughener or higher as shown by Adhesives D and E in Table 24.

The following Examples generally relate to the use of the di-amine terminated polyalkylene oxide adducted with epoxy as a toughener along with additional epoxy resin, an epoxy resin adducted with CTBN, and as a comparison, similar compositions utilizing the tri-amine terminated polyalkylene oxide compounds as a toughener. The formulations set forth herein below in Tables 25 through 37 were compounded in a manner similar to that set forth herein above with regard to the preceding Examples 1-10.

### Example 11

Di-amine terminated polyalkylene oxide, Jeffamine D 2000 and Jeffamine T 3000 were obtained from Huntsman and where adducted with an epoxy resin as set forth in Table 25.

TABLE 25
Adducts of D 2000

| | A | B | C |
|---|---|---|---|
| Epalloy 8225 | 60 | | 60 |
| Epon 828 | | 60 | |
| D 2000 | 40 | 40 | |
| T-3000 | | | 40 |

Adducts were prepared by reacting at 80° C. for 16 hours with occasional stirring.

The adducts of Table 25 were blended with the compounds set forth in Table 26 in the amounts therein and cured and then tested with regard to the indicated properties.

TABLE 26

| | A | B | C | D |
|---|---|---|---|---|
| Epon 828 | 77.5 | 77.5 | 55 | 77.5 |
| A Table 25 | 37.5 | — | | |
| B Table 25 | | 37.5 | 37.5 | |
| Epon 58005 | | | 37.5 | |
| C Table 25 | | | | 37.5 |
| Tabular Alumina | 40 | 40 | 40 | 40 |
| Dicyandiamide | 5 | 5 | 5 | 5 |
| Amicure UR | 2 | 2 | 2 | 2 |
| Cab O Sil TS 720 | 3 | 3 | 3 | 3 |
| Results | | | | |
| T-peel RT N/mm | 225.3 | 188.3 | 152.7 | 190.3 |
| T-peel @ −40° C. | 160(230.5)* | 134 | 202(151.5)* | 200(207)* |
| N/mm | | | | |
| Lap Shear @ 90° C. | 7.58 | 7.58 | 7.24 | 7.72 |
| PSI | | | | |

*Retest after 1 month aging at room conditions.

Clean EZ 60, zinc electroplated galvanized steel panels, were bonded at 10 mils bond line thickness and cured at 177° C. for 30 minutes.

Comparing Columns A and D of Table 26, the various physical properties of the di-amine terminated polyalkylene oxide toughener compared favorably with the tri-amine terminated polyalkylene tougheners of the present invention. Compare adhesives A, B and C with conventional Adhesive D.

### Example 12

Another comparison of the epoxy adducts of the di-amine terminated polyalkylene oxide toughener with the tri-amine polyalkylene toughener is set forth in Table 27.

TABLE 27
Adducts

| | A | B |
|---|---|---|
| Epalloy 8225 | 60 | 60 |
| T-3000 | 40 | |
| D 2000 | | 40 |
| Viscosity cps @ 27° C. | 257,000 | 82,000 |

Adducts were prepared by reacting at 80° C. for 16 hours.

As apparent from Table 27, the viscosity of the di-amine toughener adduct was much lower than that of the tri-amine toughener adduct. Adhesives were prepared from the adducts of Table 27, as shown in the formulations of Table 28. These two tougheners were blended to evaluate the properties of combinations of D 2000 and T 3000 in adhesives.

TABLE 28
Adhesives

| | AA | BB | CC | DD | EE |
|---|---|---|---|---|---|
| Epon 828 | 77.5 | 77.5 | 77.5 | 77.5 | 77.5 |
| A Table 27 | 37.5 | 25 | 18.7 | 12.5 | — |
| B Table 27 | — | 12.5 | 18.7 | 25 | 37.5 |
| Tabular Alumina | 40 | 40 | 40 | 40 | 40 |
| Dicy | 5 | 5 | 5 | 5 | 5 |
| Amicure UR | 2 | 2 | 2 | 2 | 2 |
| TS720 | 3 | 3 | 3 | 3 | 3 |
| Results | | | | | |
| T-peel @ RT N/mm | 201 | 207 | 169 | 229.5 | 215.8 |
| T-peel @ −40° C. N/mm | 220.5 | 221.8 | 230.5 | 230.5 | 204 |
| Lap shear @ 90° C. PSI | 7.66 | 7.44 | 7.43 | 7.58 | 7.58 |

As apparent from Table 28, Formulation EE which contained the di-amine terminated polyalkylene oxide toughener yielded results comparable to that of the tri-amine terminated polyalkylene oxide toughener as set forth in Formulation AA. The intermediate results of Formulations BB, CC, and DD were also generally very good, especially at low temperatures.

### Example 13

Epoxy adducts of the di-amine terminated polyalkylene oxide compounds were prepared as set forth in Table 29 utilizing Epon 828 and Epalloy 8225 in order to compare the properties of adducts prepared with two different epoxy resins.

TABLE 29
Adducts

| | A | B |
|---|---|---|
| D 2000 | 40 | 40 |
| Epalloy 8225 | 60 | — |
| Epon 828 | — | 60 |
| Viscosity Cps @ 27° C. | 69,000 | 167,000 |

* Reacted at 80° C. for 16 hours

As expected from Table 29, the epoxy adduct utilizing an epoxy resin made from bisphenol F has a much lower viscosity than the epoxy adduct made from bisphenol A. The epoxy-di-amine terminated polyalkylene oxide adducts of Table 29 were formulated in a manner as set forth in Table 30 and prepared into adhesives in a manner set forth hereinabove and tested.

TABLE 30
Adhesives

| | A | B | C | D |
|---|---|---|---|---|
| Epon 828 | 77.5 | 77.5 | 77.5 | 77.5 |
| A Table 29 | 37.5 | — | 37.5 | — |
| B Table 29 | — | 37.5 | — | 37.5 |
| Tabular Alumina | 40 | 40 | | |
| Dicy | 5 | 5 | 5 | 5 |
| Amicure UR 7/10 | 2 | 2 | 2 | 2 |
| TS720 | 2 | 2 | 2 | 2 |
| Results | | | | |
| T-peel @ RT N/mm | 199.5 | 185.8 | 192 | 219.8 |
| T-peel @ −40° C. N/mm | 179.8 | 170 | 100.3 | 127 |
| Lap shear @ 90° C. PSI | 6.8 | 6.8 | 6.58 | 6.8 |

In general, higher peel strengths at −40° C. were obtained utilizing the epoxy adduct prepared from bisphenol F (Formulations A and B) when using tabular alumina as a filler. Low temperature peel strength was improved by the use of tabular alumina at the 40 phr level (compare Formulation A with Formulation C and Formulation B with Formulation D).

### Example 14

A blend of tougheners was made and set forth in Table 31 wherein di-amine terminated polyalkylene oxide, D 2000, and Hycar CTBN were adducted with epoxy resin Epon 828 in a two step reaction. First, the CTBN is reacted with the epoxy resin at about 120° C. for about 4 to 5 hours and after cooling the D 2000 is added and this mixture is reacted at about 85° C. for 5 hours. The viscosity at 27° C. was 295,000 cps.

TABLE 31
Adduct

| | A |
|---|---|
| Epon 828 | 60 |
| Hycar 1300X13 | 20 |
| D 2000 | 20 |

Adhesives were made from the blend of adducts of Table 31 according to formulations set forth in Table 32 and tested by bonding clean EZ 60 galvanized steel. Bondlines were controlled at 10 mils (0.254 mm) and cured at 180° C. for 30 minutes.

TABLE 32
Adhesives

| | A | B | C | D |
|---|---|---|---|---|
| Epon 828 | 85 | 77.5 | 77.5 | 67.5 |
| Table 31 | 25 | 37.5 | 37.5 | 55 |
| Tabular Alumina | 40 | 40 | — | 40 |
| Dicy | 5 | 5 | 5 | 5 |
| Amicure UR 7/10 | 2 | 2 | 2 | 2 |
| TS720 | 3 | 3 | 3 | 3 |
| Parts of toughener | 10 | 15 | 15 | 22 |
| Results | | | | |
| T-peel @ RT N/25 mm | 148.5 | 185.5 | 185.5 | 255 |
| T-peel @ −40° C. N/25 mm | 84.5 | 103.5 | 70.5 | 190 |
| Lap shear @ 90° C. Mpa | 7.03 | 7.03 | 6.78 | 6.96 |

As shown in Table 32 Tabular Aluminum appears to have a strong positive effect on low temperature T-peel of this particular toughener (compare adhesive B to Adhesive C. Overall peel properties were good.

### Example 15

Epoxy adducts of a tri-amine terminated polypropylene oxide toughener and a di-amine terminated polypropylene oxide toughener were evaluated with and without tabular alumina were prepared as set forth in Table 33.

TABLE 33
Adducts

| | A | B | C |
|---|---|---|---|
| Epon 828 | | | 60 |
| Epalloy 8225 | 60 | 60 | |
| T-3000 | | 40 | |
| D 2000 | 40 | | 40 |
| Viscosity Cps @ 27° C. | 33,500 | 129,000 | 136,000 |

Adhesives were made from the adducts of Table 33 with tabular alumina as set forth in the formulations of Table 34.

TABLE 34
Adhesives and Results with Tabular Alumina

| | A | B | C | D | E |
|---|---|---|---|---|---|
| A from Table 33 | 37.5 | | | | |
| B from Table 33 | | 37.5 | | | |
| C from Table 33 | | | 37.5 | | |
| Adduct from Table 31 | | | | 37.5 | 55 |
| Epon 828 | 77.5 | 77.5 | 77.5 | 77.5 | 67.5 |
| Tabular Alumina | 40 | 40 | 40 | 40 | 40 |
| Dicy | 5 | 5 | 5 | 5 | 5 |
| Amicure UR 7/10 | 2 | 2 | 2 | 2 | 2 |
| TS720 | 3 | 3 | 3 | 3 | 3 |
| Parts of Toughener | 15 | 15 | 15 | 15 | 22 |
| Results | | | | | |
| T-peel @ −40° C. | 101.75 | 233.25 | 121.25 | 102.5 | 152.5 |
| N/25 mm | | | | | |
| T-peel @ RT N/25 mm | 187.25 | 226.25 | 187.75 | 201.25 | 255 |
| Lap shear @ 90° C. | 6.8 | 7.17 | 7.17 | 7.24 | 6.97 |
| Mpa | | | | | |

As apparent from Table 34 T 3000 adducts provide the better T-peel properties at low temperatures when compared to D 2000. The mixed toughener, adhesive E, gave the highest RT peel of this series.

In Table 35 adhesives were prepared without tabular alumina to determine the effect of this particular filler on peel and shear properties.

TABLE 35
Adhesives

| | A | B | C | D | E |
|---|---|---|---|---|---|
| A from Table 33 | 37.5 | | | 37.5 | |
| B from Table 33 | | 37.5 | | | |
| C from Table 33 | | | 37.5 | | |
| Epon 58005 | | | | | 37.5 |
| Epalloy 8225 | | | | 77.5 | |
| Epon 828 | 77.5 | 77.5 | 77.5 | | 77.5 |
| Dicy | 5 | 5 | 5 | 5 | 5 |
| Amicure UR 7/10 | 2 | 2 | 2 | 2 | 2 |
| Cob O Sil TS 720 | 3 | 3 | 3 | 3 | 3 |
| Parts of Toughener | 15 | 15 | 15 | 15 | 15 |
| Test Results | | | | | |
| −40° C. T-peel N/25 mm | 61 | 209 | 100 | 81 | 63.5 |
| RT T-peel N/25 mm | 207 | 210 | 192.5 | 194 | 200 |
| 90° C. Lap Shear Mpa | 5.68 | 6.57 | 6.17 | 6.23 | 6.88 |

From a comparison of A, B and C of Table 35 to A, B and C in Table 34 it is apparent that tabular alumina provides an increase in low temperature peel with the particular peel test used in this work. However, the peel strength of adhesive B (Table 34 and 35) which used T-3000 as the toughener is only slightly affected by the use of tabular alumina.

### Example 16

Neat D 2000 was evaluated a sole toughener in an epoxy adhesive as shown in Table 35. The adhesives were prepared and aged two days before bonding clean EZ 60 metals. Bond lines were controlled at 10 mils (0.254 mm) and adhesives were cured at 180° C. for 30 minutes. Results are shown in Table 36.

TABLE 36
D 2000 in Adhesives

| | A | B | C |
|---|---|---|---|
| D 2000 | 15 | 15 | — |
| Tabular Alumina | 40 | — | 40 |
| Epon 828 | 100 | 100 | 77.5 |
| A from Table 33 | | | 37.5 |
| Amicure CG 1400 | 5 | 5 | 5 |
| Amicure UR 7/10 | 2 | 2 | 2 |
| Cab OSil TS 720 | 3 | 3 | 3 |
| Test Results | | | |
| T-peel @ RT N/25 mm | 145 | 150 | 218 |
| T-peel @ −40° C. N/25 mm | 55 | 55 | 214 |
| Lap shear @ 90° C. Mpa | 7.24 | 6.81 | 7.17 |

The results of these tests show that neat D 2000 is an adequate toughener for epoxy based adhesives when added as a neat liquid. Clearly the adduct (Adhesives C in Table 36,) provides superiority properties under these testing conditions. In this example the use of the filler Tabular Alumina had little effect on the properties, compare Adhesive A to Adhesive B.

### Example 17

A mixed toughener adduct was prepared utilizing equal amounts of four different tougheners as shown in Table 37.

TABLE 37
Adduct Blends*

| | |
|---|---|
| Epon 58005 | 25 |
| EXL 2691 A | 10* |
| Epon 828 | 15 |
| Epalloy 8225 | 30* |
| T-3000 | 10 |
| D 2000 | 10 |

*Epalloy 8225 and EXL 2691A were mixed for three hours at about 30°-50° C. Epon 58005, T3000 and D 2000 were added and reacted at 80° C. for about 12 hours.

The toughener of Table 37 was then formulated with various other compounds to prepare adhesives having the formulation set forth in Table 30 and then tested. EZ 60 panels were bonded with bond lines controlled at 10 mils and the cure was 30 minutes at 177° C.

TABLE 38
Adhesives

| | A | B | C |
|---|---|---|---|
| Blend of Table 37 | 37.5 | 55.5 | 75 |
| Epon 828 | 77.5 | 67 | 55 |
| Tabular Alumina | 40 | 40 | 40 |
| Dicy | 5 | 5 | 5 |
| TS720 | 3 | 3 | 3 |
| Amicure UR | 2 | 2 | 2 |
| Parts of Toughener | 15 | 22.2 | 30 |
| Results | | | |
| RT T-peel N/mm | 209. | 267.5 | 282 |
| T-peel @ −40° C. N/mm | 167.5 | 237 | 267 |
| Lap shear @ 90° C. PSI | 7.45 | 7.44 | 7.65 |

As apparent from Table 38, as the amount of toughener increased, the peel strengths also increased. Peel properties were very good at all temperatures and at all levels tested. These types of toughener blends are very effective in toughening epoxy resin.

The toughened epoxies of the present invention can be utilized wherever epoxy resins have been used and desirably have good toughness and especially low temperature peel resistance strength. Accordingly, numerous applications exist in the aerospace and automotive industries. Generally the toughened epoxy resins of the present invention can be used as paste and film structural adhesives, for the production of various specific articles, components, and structural forms such as bonding of automotive and aerospace components. These types of toughened adhesive products will find use in any material or bonding application requiring excellent low temperature toughness as well as toughness and impact resistance. Tougheners of the present invention are effective in systems that do not contain higher molecular epoxy resins or polymers. Therefore adhesives with lower viscosity can be formulated and still have exceptional peel strength.

Blends of any of the embodiments may be utilized to enhance toughness and to improve or optimize other properties such as viscosity and Tg. As an example the following mixture of toughening concepts is shown below.

| Toughener Blend* | |
|---|---|
| Epalloy 8225 (Bis F Resin) | 60 − W |
| Epon 828 (Bis A Resin) | W |
| Hycar 1300X13** | 40 − (X + Y + Z) |
| EXL 2691A (core shell) | X |
| Jeffamine T-3000 | Y |
| Jeffamine D 2000 | Z |

*60/40 adduct (60% epoxy resins and 40% Tougheners)
**Hycar 1300X8 may also be used providing that it is soluble in the toughener blends.

Using Bis F and D 2000 will lower viscosity of the adduct while adding Hycar 1300X13, T 3000 and core shell particles will help to optimize peel. Core shell particles could help to maintain Tg for the cured adhesive. The only additional requirement is that the blend is compatible and remains stable to phasing while being stored prior to use.

In accordance with the patent statutes, the best mode and preferred embodiment have been set forth, the scope of the invention is not limited thereto, but rather by the scope of the attached claims.

What is claimed is:

1. An uncured, epoxy blend composition, comprising:
a) a liquid epoxy resin having a weight average equivalent weight of about 300 or less;
b1) a tri-amine terminated polyalkylene oxide toughener having three chains, each chain, independently, derived from an alkylene oxide having from 3 or 4 carbon atoms and wherein the total weight average molecular weight of said toughener is from about 2,000 to about 4,000; and wherein the amount of said tri-amine terminated polyalkylene oxide toughener is from about 5 to about 30 parts by weight per 100 total parts by weight of said epoxy resin; or
b2) an amine terminated polyalkylene oxide tri-block polymer toughener wherein each block, independently, contains repeat groups having from 3 or 4 carbon atoms, and the total weight average molecular weight is from about 800 to about 2,000; and wherein the amount of said amine terminated polyalkylene oxide tri-block polymer toughener is from about 5 to about 30 parts by weight per 100 total parts by weight of said epoxy resin; or
b3) a di-amine terminated polyalkylene oxide toughener having two chains, each chain, independently, derived from an alkylene oxide having from 3 or 4 carbon atoms and wherein the total weight average molecular weight of said toughener is from about 1,000 to about 3,000; and wherein the amount of said tri-amine terminated polyalkylene oxide toughener is from about 5 to about 30 parts by weight per 100 total parts by weight of said epoxy resin.

2. The uncured, epoxy blend composition of claim 1, wherein said epoxy resin comprises a glycidyl ether of a novolac resin; a glycidyl ether of one or more of a mono-, di-, or trihydric phenol; a glycidyl ether of one or more of bisphenol A or bisphenol F; a glycidyl ether of a polynuclear phenol; an epoxy resin derived from diphenolic acid; a glycidyl ether of an aliphatic polyol; a glycidyl ester; a glycidyl epoxy containing a nitrogen atom; a glycidyl derivative of cyanuric acid; a glycidyl resin of a melamine; a glycidyl amine; a glycidyl triazine; a thioglycidyl resin; a silicon-glycidyl resin; a fluorine glycidyl resin; an epoxy resin derived from a mono-epoxy other than an epihalohydrin; an epoxy resin derived from a monoepoxy, alcohol; an epoxy resin derived from a monoepoxy by ester interchange; an epoxy resin derived from a glycidaldehyde; a polyglycidyl compound containing unsaturation; or an epoxy resin that is synthesized from an olefin and a chloroacetyl; or any combination thereof;
wherein said amine of said tri-amine terminated polyalkylene oxide toughener, independently, is a primary amine or a secondary amine;
wherein each said terminal amine of said amine terminated polyalkylene oxide tri-block polymer toughener, independently, is a primary amine or a secondary amine, and
wherein said amine of said di-amine terminated polyalkylene oxide toughener, independently, is a primary amine or a secondary amine.

3. The uncured, epoxy blend composition of claim 2, wherein the amount of said tri-amine terminated polyalkylene oxide toughener is from about 5 to about 25 parts by weight per 100 parts by weight of said epoxy resin, wherein said polyalkylene oxide is derived from a total of about 30 to about 70 moles of said one or more alkylene oxides, and wherein the weight average molecular weight of said tri-amine terminated polyalkylene oxide toughener is from about 2,500 to about 3,500;
wherein the amount of said amine terminated polyalkylene oxide tri-block polymer toughener is from about 5 to about 25 parts by weight per 100 parts by weight of said epoxy resin, and wherein the weight average molecular weight of said amine terminated polyalkylene oxide tri-block polymer toughener is from about 1,000 to about 1,500; and
wherein the amount of said di-amine terminated polyalkylene oxide toughener is from about 5 to about 25 parts by weight per 100 parts by weight of said epoxy resin, and wherein the weight average molecular weight of said di-amine terminated polyalkylene oxide toughener is from about 1,500 to about 2,500.

4. The uncured, epoxy blend composition of claim 3, wherein said epoxy resin equivalent weight is about 200 or less, wherein said epoxy resin is the diglycidyl ether of bisphenol A, or the diglycidyl ether of bisphenol F, or a combination thereof;
wherein the amount of said tri-amine terminated polyalkylene oxide toughener is from about 13 to about 18 parts by weight per 100 parts by weight of said epoxy resin, wherein each said chain is derived from propylene oxide and wherein said total number of said propylene oxide moles is from about 40 to about 60 moles, wherein said terminal amine is a primary amine, wherein the weight average molecular weight of said tri-amine terminated polyalkylene oxide toughener is from about 2,800 to about 3,200;
wherein the amount of said amine terminated polyalkylene oxide tri-block polymer toughener is from about 13 to about 18 parts by weight per 100 parts by weight of said epoxy resin, wherein said tri-block polymer is a polypropylene oxide (PPO)-polytretramethylene oxide (PTMO)-polypropylene oxide (PPO) triblock polymer having a mole ratio of (PPO) repeat groups to (PTMO) repeat groups of about 2 to about 10, wherein said terminal amine is a primary amine, wherein the weight average molecular weight of said tri-amine terminated polyalkylene oxide tri-block polymer toughener is from about 1,000 to about 1,400; and
wherein the amount of said di-amine terminated polyalkylene oxide toughener is from about 13 to about 18 parts by weight per 100 parts by weight of said epoxy resin, wherein each said chain is derived from propylene oxide, wherein said terminal amine is a primary amine, wherein the weight average molecular weight of said tri-amine terminated polyalkylene oxide toughener is from about 1,800 to about 2,200.

5. The uncured, epoxy blend composition of claim 1, wherein said epoxy resin comprises a glycidyl ether of a novolac resin; a glycidyl ether of one or more of a mono-, di-, or trihydric phenol; a glycidyl ether of one or more of bisphenol A or bisphenol F; a glycidyl ether of a polynuclear phenol; an epoxy resin derived from diphenolic acid; a glycidyl ether of an aliphatic polyol; a glycidyl ester; a glycidyl epoxy containing a nitrogen atom; a glycidyl derivative of cyanuric acid; a glycidyl resin of a melamine; a glycidyl amine; a glycidyl triazine; a thioglycidyl resin; a silicon-glycidyl resin; a fluorine glycidyl resin; an epoxy resin derived from a mono-epoxy other than an epihalohydrin; an epoxy resin derived from a monoepoxy alcohol; an epoxy resin derived from a monoepoxy by ester interchange; an epoxy resin derived from a glycidaldehyde; a polyglycidyl compound containing unsaturation; or an epoxy resin that is synthesized from an olefin and a chloroacetyl; or any combination thereof;
wherein at least a portion to all of said tri-amine terminated polyalkylene oxide toughener is incorporated into said epoxy blend composition as a tri-amine-epoxy adduct compound containing from about 10% to about 60% by weight of said tri-amine terminated polyalkylene oxide toughener therein, and wherein said epoxy of said tri-amine-epoxy adduct constitutes part of said 100 total parts by weight of said epoxy resin;
wherein at least a portion to all of said amine terminated polyalkylene oxide tri-block polymer toughener is incorporated into said epoxy blend composition as an amine tri-block polymer-epoxy adduct compound containing from about 10 to about 60% by weight of said amine terminated polyalkylene oxide tri-block polymer toughener therein, and wherein said epoxy of said amine tri-block polymer-epoxy adduct constitutes part of said 100 total parts by weight of said epoxy resin; and
wherein at least a portion to all of said di-amine terminated polyalkylene oxide toughener is incorporated into said epoxy blend composition as a di-amine-epoxy adduct compound containing from about 10% to about 60% by weight of said di-amine terminated polyalkylene oxide toughener therein, and wherein said epoxy of said di-amine-epoxy adduct constitutes part of said 100 total parts by weight of said epoxy resin.

6. The uncured, epoxy blend composition of claim 5, wherein, independently, said epoxy of said tri-amine-epoxy adduct, or said tri-block polymer-epoxy adduct, or said diamine-epoxy adduct, is derived from a glycidyl ether of a novolac resin; a glycidyl ether of one or more of a mono-, di-, or trihydric phenol; a glycidyl ether of one or more of a bisphenol A or bisphenol F; a glycidyl ether of a polynuclear phenol; an epoxy resin derived from diphenolic acid; a glycidyl ether of an aliphatic polyol; a glycidyl ester; a glycidyl epoxy containing a nitrogen atom; a glycidyl derivative of cyanuric acid; a glycidyl resin of a melamine; a glycidyl amine; a glycidyl triazine; a thioglycidyl resin; a silicon-glycidyl resin; a fluorine glycidyl resin; an epoxy resin derived from a mono-epoxy other than an epihalohydrin; an epoxy resin derived from a monoepoxy alcohol; an epoxy resin derived from a monoepoxy by ester interchange; an epoxy resin derived from a glycidaldehyde; a polyglycidyl compound containing unsaturation; or an epoxy resin that is synthesized from an olefin and a chloroacetyl; or any combination thereof; and
wherein said amine of said tri-amine terminated polyalkylene oxide toughener, or said amine of said amine terminated polyalkylene oxide tri-block polymer toughener, or said amine of said diamine terminated polyalkylene oxide toughener, independently, is a primary amine or a secondary amine.

7. The uncured, epoxy blend composition of claim, 6, wherein the amount of said tri-amine terminated polyalkylene oxide toughener is from about to about 25 parts by weight per 100 parts by weight of said epoxy resin, wherein said polyalkylene oxide is derived from a total of about 30 to about 70 moles of said one or more alkylene oxides, and wherein the weight average molecular weight of said tri-amine terminated polyalkylene oxide toughener is from about 2,500 to about 3,500, and wherein the amount of said tri-amine terminated polyalkylene oxide toughener in said tri-amine-epoxy adduct compound is from about 15% to about 50% by weight;
wherein the amount of said amine terminated polyalkylene oxide tri-block polymer toughener is from about 5 to about 25 parts by weight per 100 parts by weight of said epoxy resin, wherein the weight average molecular weight of said amine terminated polyalkylene oxide tri-block polymer toughener is from about 1,000 to about 1,500, and wherein the amount of said amine terminated polyalkylene oxide tri-block polymer toughener in said amine tri-block polymer-epoxy adduct compound is from about 15% to about 50% by weight; and
wherein the amount of said di-amine terminated polyalkylene oxide toughener is from about 5 to about 25 parts by weight per 100 parts by weight of said epoxy resin, and wherein the weight average molecular weight of said di-amine terminated polyalkylene oxide toughener is from about 1,500 to about 2,500, and wherein the amount of said di-amine terminated polyalkylene oxide toughener in said di-amine-epoxy adduct compound is from about 15% to about 50% by weight.

8. The uncured, epoxy blend composition of claim 7, wherein said epoxy resin equivalent weight is about 200 or less, wherein said epoxy resin is the diglycidyl ether of bisphenol A, or the diglycidyl ether of bisphenol F, or a combination thereof;
wherein the amount of said tri-amine terminated polyalkylene oxide toughener is from about 13 to about 18 parts by weight per 100 parts by weight of said epoxy resin, wherein each said chain is derived from propylene oxide and wherein the total number of said propylene oxide moles is from about 40 to about 60 moles, wherein said terminal amine is a primary amine, wherein the weight average molecular weight of said tri-amine terminated polyalkylene oxide toughener is from about 2,800 to about 3,200; wherein the amount of said tri-amine terminated polyalkylene oxide toughener in said tri-amine-epoxy adduct is from about 25% to about 50% by weight, and wherein said epoxy of the tri-amine-epoxy adduct is derived from neopentyl glycol diglycidyl ether, 1,4-butane diol diglycidyl ether, cyclohexanedimethanol diglycidyl ether, a diglycidyl ether bisphenol A, or a diglycidyl bisphenol F, or any combination thereof;
wherein the amount of said amine terminated polyalkylene oxide tri-block polymer toughener is from about 13 to about 18 parts by weight per 100 parts by weight of said epoxy resin, wherein said tri-block polymer is a polypropylene oxide (PPO)-polytetramethylene oxide (PTMO)-polypropylene oxide (PPO) tri-block polymer having a mole ratio of (PPO) repeat groups to (PTMO) repeat groups of from about 2 to about 10, wherein each said terminal amine is a primary amine, wherein the weight average molecular weight of said amine terminated polyalkylene oxide tri-block polymer toughener is from about 1,000 to about 1,400; wherein the amount of said amine terminated polyalkylene oxide tri-block polymer toughener in said amine tri-block polymer-epoxy adduct is from about 25% to about 50% by weight, and wherein said epoxy in the adducted tri-block polymer-epoxy adduct is derived from neopentyl glycol diglycidyl ether, 1,4-butane diol diglycidyl ether, cyclohexanedimethanol diglycidyl ether, a diglycidyl ether of bisphenol A, or a diglycidyl ether of bisphenol F, or any combination thereof; and
wherein the amount of said di-amine terminated polyalkylene oxide toughener is from about 13 to about 18 parts by weight per 100 parts by weight of said epoxy resin, wherein each said chain is derived from propylene oxide, wherein said terminal amine is a primary amine, wherein the weight average molecular weight of said di-amine terminated polyalkylene oxide toughener is from about 1,800 to about 2,200; wherein the amount of said di-amine terminated polyalkylene oxide toughener in said di-amine-epoxy adduct is from about 25% to about 50% by weight, and wherein said epoxy of the di-amine-epoxy adduct is derived from neopentyl glycol diglycidyl ether, 1,4-butane diol diglycidyl ether, cyclohexanedimethanol diglycidyl ether, a diglycidyl ether bisphenol A, or a diglycidyl bisphenol F, or any combination thereof.

9. The uncured, epoxy blend composition of claim 1, further comprising a core-shell polymer, wherein the amount of said core-shell polymer is from about 5 to about 30 parts by weight per 100 total parts by weight of said epoxy resin, and wherein said core of said core-shell polymer has a Tg of about minus 25° C. or less.

10. The uncured, epoxy blend composition of claim 9, wherein said epoxy resin comprises a glycidyl ether of a novolac resin; a glycidyl ether of one or more of a mono-, di-, or trihydric phenol; a glycidyl ether of one or more of a bisphenol A or bisphenol F; a glycidyl ether of a polynuclear phenol; an epoxy resin derived from diphenolic acid; a glycidyl ether of an aliphatic polyol; a glycidyl ester; a glycidyl epoxy containing a nitrogen atom; a glycidyl derivative of cyanuric acid; a glycidyl resin of a melamine; a glycidyl amine; a glycidyl triazine; a thioglycidyl resin; a silicon-glycidyl resin; a fluorine glycidyl resin; an epoxy resin derived from a mono-epoxy other than an epihalohydrin; an epoxy resin derived from a monoepoxy alcohol; an epoxy resin derived from a monoepoxy by ester interchange; an epoxy resin derived from a glycidaldehyde; a polyglycidyl compound containing unsaturation; or an epoxy resin that is synthesized from an olefin and a chloroacetyl; or any combination thereof;
wherein said amine of said tri-amine terminated polyalkylene oxide toughener is a primary amine or a secondary amine, wherein the amount of said tri-amine terminated polyalkylene oxide toughener is from about 5 to about 25 parts by weight per 100 total parts by weight of said epoxy resin, wherein said polyalkylene oxide is derived from a total of about 30 to about 70 moles of said one or more alkylene oxides, wherein the weight average molecular weight of said tri-amine terminated polyalkylene oxide toughener is from about 2,500 to about 3,500;
wherein said amine of said amine terminated polyalkylene oxide tri-block polymer toughener, independently, is a primary amine or a secondary amine, wherein the amount of said amine terminated polyalkylene oxide tri-block polymer toughener is from about 5 to about 25 parts by weight per 100 total parts by weight of said epoxy resin, wherein the weight average molecular weight of said amine terminated polyalkylene oxide tri-block polymer toughener is from about 1,000 to about 1,500;
wherein said amine of said di-amine terminated polyalkylene oxide toughener is a primary amine or a secondary amine, wherein the amount of said tri-amine terminated polyalkylene oxide toughener is from about 5 to about 25 parts by weight per 100 total parts by weight of said epoxy resin, wherein the weight average molecular weight of said di-amine terminated polyalkylene oxide toughener is from about 1,500 to about 2,500; and
wherein the amount of said core-shell polymer is from about 10 to about 30 parts by weight per 100 total parts by weight of said epoxy resin, wherein said core is derived from at least a conjugated diene having from 4 to 6 carbon atoms and optionally a vinyl substituted aromatic having from 8 to about 12 carbon atoms, or from an alkyl acrylate wherein the alkyl portion has from 4 to about 15 carbon atoms, and wherein said shell is derived from an alkyl methacrylate wherein said alkyl group has from 1 to about 4 carbon atoms.

11. The uncured, epoxy blend composition of claim 10, wherein the amount of said tri-amine terminated polyalkylene oxide toughener is from about 13 to about 18 parts by weight per 100 parts by weight of said epoxy resin, wherein each said chain is derived from propylene oxide and wherein the total number of said propylene oxide moles is from about 40 to about 60 moles, wherein said terminal amine is a primary amine, wherein the weight average molecular weight of said tri-amine terminated polyalkylene oxide toughener is from about 2,800 to about 3,200;
wherein the amount of said amine terminated polyalkylene oxide tri-block polymer toughener is from about 13 to about 18 parts by weight per 100 parts by weight of said epoxy resin, wherein said tri-block polymer is a polypropylene oxide (PPO)-polytetramethylene oxide (PTMO)-polypropylene oxide (PPO) tri-block polymer having a mole ratio of (PPO) repeat groups to (PTMO) repeat groups of from about 2 to about 10, wherein each said terminal amine is a primary amine, wherein the weight average molecular weight of said amine terminated polyalkylene oxide tri-block polymer toughener is from about 1,000 to about 1,400;
wherein the amount of said di-amine terminated polyalkylene oxide toughener is from about 13 to about 18 parts by weight per 100 parts by weight of said epoxy resin, wherein said terminal amine is a primary amine, wherein the weight average molecular weight of said tri-amine terminated polyalkylene oxide toughener is from about 1,800 to about 2,200;
wherein the viscosity of said uncured epoxy composition at 27° C. is about 100,000 to about 300,000 centipose;
wherein said epoxy resin equivalent weight is about 200 or less;
wherein said epoxy resin is the diglycidyl ether of bisphenol A, or the diglycidyl ether of bisphenol F, or a combination thereof; and
wherein the amount of said core-shell polymer is from about 15 to about 25 parts by weight per 100 total parts by weight of said epoxy resin, wherein said core-shell polymer has a Tg of about minus 45° C. or less, wherein said core is derived from butadiene or from butadiene and styrene, and wherein said shell is derived from methyl methacrylate.

12. The uncured, epoxy blend composition of claim 6, further comprising a core-shell polymer, wherein the amount of said core-shell polymer is from about 5 to about 30 parts by weight per 100 total parts by weight of said epoxy resin, and wherein said core-shell polymer has a Tg of about minus 25° C. or less.

13. The uncured, epoxy blend composition of claim 12,
wherein the amount of said tri-amine terminated polyalkylene oxide toughener is from about 5 to about 25 parts by weight per 100 total parts by weight of said epoxy resin, wherein said polyalkylene oxide is derived from a total of about 30 to about 70 moles of said one or more alkylene oxides, wherein the weight average molecular weight of said tri-amine terminated polyalkylene oxide toughener is from about 2,500 to about 3,500;
wherein the amount of said amine terminated polyalkylene oxide tri-block polymer toughener is from about 5 to about 25 parts by weight per 100 total parts by weight of said epoxy resin, wherein the weight average molecular weight of said amine terminated polyalkylene oxide tri-block polymer toughener is from about 1,000 to about 1,500;
wherein the amount of said di-amine terminated polyalkylene oxide toughener is from about 5 to about 25 parts by weight per 100 total parts by weight of said epoxy resin, wherein the weight average molecular weight of said di-amine terminated polyalkylene oxide toughener is from about 1,500 to about 2,500; and
wherein the amount of said core-shell polymer is from about 10 to about 30 parts by weight per 100 total parts by weight of said epoxy resin, wherein said core is derived from at least a conjugated diene having from 4 to 6 carbon atoms and optionally a vinyl substituted aromatic having from 8 to about 12 carbon atoms, or from an alkyl alkylacrylate wherein the alkyl portion has from 4 to about 15 carbon atoms, and wherein said shell is derived from an alkyl methacrylate wherein said alkyl group has from 1 to about 4 carbon atoms.

14. The uncured, epoxy blend composition of claim 13, wherein, independently, said epoxy of the tri-amine-epoxy adduct, or said amine terminated tri-block polymer-epoxy adduct compound, or said di-amine adduct compound, is derived from neopentyl glycol diglycidyl ether, 1,4-butane diol diglycidyl ether, cyclohexanedimethanol diglycidyl ether, a diglycidyl ether bisphenol A, or an diglycidyl bisphenol F, or any combination thereof;
wherein the amount of said tri-amine terminated polyalkylene oxide toughener is from about 13 to about 18 parts by weight per 100 parts by weight of said epoxy resin, wherein each said side chain is derived from propylene oxide and wherein the total number of said propylene oxide moles is from about 40 to about 60 moles, wherein said terminal amine is a primary amine, wherein the weight average molecular weight of said tri-amine terminated polyalkylene oxide toughener is from about 2,800 to about 3,200, wherein the amount of said amine terminated polyalkylene oxide toughener in said tri-amine-epoxy adduct compound is from about 25% to about 50% by weight;
wherein the amount of said amine terminated polyalkylene oxide tri-block polymer toughener is from about 13 to about 18 parts by weight per 100 parts by weight of said epoxy resin, wherein said tri-block polymer is a polypropylene oxide (PPO)-polytetramethylene oxide (PTMO)-polypropylene oxide (PPO) tri-block polymer having a mole ratio of (PPO) repeat groups to (PTMO) repeat groups of from about 2 to about 10, wherein each said terminal amine is a primary amine, wherein the weight average molecular weight of said amine terminated polyalkylene oxide tri-block polymer toughener is from about 1,000 to about 1,400, wherein the amount of said amine terminated polyalkylene oxide tri-block polymer toughener in said amine terminated tri-block polymer-epoxy adduct compound is from about 25% to about 50% by weight;
wherein the amount of said di-amine terminated polyalkylene oxide toughener is from about 13 to about 18 parts by weight per 100 parts by weight of said epoxy resin, wherein each said side chain is derived from propylene oxide, wherein said terminal amine is a primary amine, wherein the weight average molecular weight of said di-amine terminated polyalkylene oxide toughener is from about 1,800 to about 2,200; wherein the amount of said amine terminated polyalkylene oxide toughener in said di-amine-epoxy adduct compound is from about 25% to about 50% by weight;
wherein said epoxy resin equivalent weight is about 200 or less;
wherein said epoxy resin is the diglycidyl ether of bisphenol A, or the diglycidyl ether of bisphenol F, or a combination thereof;
wherein the amount of said core-shell polymer is from about 15 to about 25 parts by weight per 100 total parts by weight of said epoxy resin, wherein said core-shell polymer has a Tg of about minus 45° C. or less, wherein said core is derived from butadiene or from butadiene and styrene, and wherein said shell is derived from methyl methacrylate, and
wherein the viscosity of said uncured epoxy composition at 27° C. is about 100,000 to about 300,000 centipose.

15. The uncured, epoxy blend composition of claim 1, further comprising an epoxy adduct of a carboxylated butadiene-acrylonitrile copolymer, wherein the weight amount of said carboxylated butadiene acrylonitrile copolymer (CTBN) is from about 5 to about 30 parts by weight per 100 total parts by weight of said epoxy resins, wherein the amount of said CTBN in said epoxy adducted CTBN copolymer is from about 10% to about 60% by weight; wherein said epoxy adduct of said CTBN is derived from a glycidyl ether of a novolac resin; a glycidyl ether of one or more of a mono-, di-, or trihydric phenol; a glycidyl ether of one or more of bisphenol A or bisphenol F; a glycidyl ether of a polynuclear phenol; an epoxy resin derived from diphenolic acid; a glycidyl ether of an aliphatic polyol; a glycidyl ester; a glycidyl epoxy containing a nitrogen atom; a glycidyl derivative of cyanuric acid; a glycidyl resin of a melamine; a glycidyl amine; a glycidyl triazine; a thioglycidyl resin; a silicon-glycidyl resin; a fluorine glycidyl resin; an epoxy resin derived from a mono-epoxy other than an epihalohydrin; an epoxy resin derived from a monoepoxy alcohol; an epoxy resin derived from a monoepoxy by ester interchange; an epoxy resin derived from a glycidaldehyde; a polyglycidyl compound containing unsaturation; or an epoxy resin that is synthesized from an olefin and a chloroacetyl; or any combination thereof;
wherein said epoxy resin comprises a glycidyl ether of a novolac resin; a glycidyl ether of one or more of a mono-, di-, or trihydric phenol; a glycidyl ether of one or more of a bisphenol A or bisphenol F; a glycidyl ether of a polynuclear phenol; an epoxy resin derived from diphenolic acid; a glycidyl ether of an aliphatic polyol; a glycidyl ester; a glycidyl epoxy containing a nitrogen atom; a glycidyl derivative of cyanuric acid; a glycidyl resin of a melamine; a glycidyl amine; a glycidyl triazine; a thioglycidyl resin; a silicon-glycidyl resin; a fluorine glycidyl resin; an epoxy resin derived from a mono-epoxy other than an epihalohydrin; an epoxy resin derived from a monoepoxy alcohol; an epoxy resin derived from a monoepoxy by ester interchange; an epoxy resin derived from a glycidaldehyde; a polyglycidyl compound containing unsaturation; or an epoxy resin that is synthesized from an olefin and a chloroacetyl; or any combination thereof;
wherein said amine of said tri-amine terminated polyalkylene oxide toughener, independently, is a primary amine or a secondary amine, wherein the amount of said tri-amine terminated polyalkylene oxide toughener is from about 5 to about 25 parts by weight per 100 total parts by weight of said epoxy resin, wherein said polyalkylene oxide is derived from a total of about 30 to about 70 moles of said one or more alkylene oxides, wherein the weight average molecular weight of said tri-amine terminated polyalkylene oxide toughener is from about 2,500 to about 3,500;
wherein said amine of said amine terminated polyalkylene oxide tri-block polymer toughener, independently, is a primary amine or a secondary amine, wherein the amount of said amine terminated polyalkylene oxide tri-block polymer toughener is from about 5 to about 25 parts by weight per 100 total parts by weight of said epoxy resin, wherein the weight average molecular weight of said amine terminated polyalkylene oxide tri-block polymer toughener is from about 1,000 to about 1,500;
wherein said amine of said di-amine terminated polyalkylene oxide toughener, independently, is a primary amine or a secondary amine, wherein the amount of said di-amine terminated polyalkylene oxide toughener is from about 5 to about 25 parts by weight per 100 total parts by weight of said epoxy resin, wherein the weight average molecular weight of said tri-amine terminated polyalkylene oxide toughener is from about 1,500 to about 2,500; and
wherein said epoxy of said epoxy adducted CTBN copolymer is derived from an epoxy resin that has two epoxy end groups.

16. The uncured, epoxy blend composition of claim 15, wherein said epoxy resin is the diglycidyl ether of bisphenol A, or the diglycidyl ether of bisphenol F, or a combination thereof, wherein said epoxy resin equivalent weight is from about 1,800 to about 2,200;
wherein the amount of said tri-amine terminated polyalkylene oxide toughener is from about 13 to about 18 parts by weight per 100 total parts by weight of said epoxy resins, wherein each said chain is derived from propylene oxide and wherein the total number of said propylene oxide moles is from about 40 to about 60 moles, wherein said terminal amine is a primary amine, wherein the weight average molecular weight of said tri-amine terminated polyalkylene oxide toughener is from about 2,800 to about 3,200;
wherein the amount of said amine terminated polyalkylene oxide tri-block polymer toughener is from about 13 to about 18 parts by weight per 100 parts by weight of said epoxy resin, wherein said tri-block polymer is a polypropylene oxide (PPO)-polytetramethylene oxide (PTMO)-polypropylene oxide (PPO) tri-block polymer having a mole ratio of (PPO) repeat groups to (PTMO) repeat groups of from about 2 to about 10, wherein each said terminal amine is a primary amine, wherein the weight average molecular weight of said amine terminated polyalkylene oxide tri-block polymer toughener is from about 1,000 to about 1,400, wherein the amount of said amine terminated polyalkylene oxide tri-block polymer toughener in said amine terminated tri-block polymer-epoxy adduct compound is from about 25% to about 50% by weight;
wherein the amount of said di-amine terminated polyalkylene oxide toughener is from about 13 to about 18 parts by weight per 100 total parts by weight of said epoxy resins, wherein each said chain is derived from propylene oxide, wherein said terminal amine is a primary amine, wherein the weight average molecular weight of said di-amine terminated polyalkylene oxide toughener is from about 1,800 to about 2,200;
wherein the amount of said carboxylated butadiene-acrylonitrile copolymer is from about 13 to about 18 parts by weight per 100 total parts by weight of said epoxy resins, wherein the amount of said carboxylated butadiene-acrylonitrile copolymer in said epoxy adducted CTBN copolymer is from about 25% to about 50% by weight, wherein said epoxy in said epoxy adduct/CTBN copolymer is the diglycidyl ether of bisphenol A, or the diglycidyl ether of bisphenol F, or a combination thereof; and
wherein the viscosity of said uncured epoxy composition at 27° C. is about 100,000 to about 300,000 centipose.

17. The uncured, epoxy blend composition of claim 6, further comprising an epoxy adduct of a carboxylated butadiene-acrylonitrile copolymer, wherein the weight amount of said epoxy adducted carboxylated butadiene-acrylonitrile copolymer (CTBN) is from about 5 to about 30 parts by weight per 100 total parts by weight of said epoxy resins, and wherein the amount of said CTBN copolymer in said epoxy adducted CTBN copolymer is from about 10% to about 60% by weight; wherein said epoxy of the epoxy adduct of CTBN is derived from a glycidyl ether of a novolac resin; a glycidyl ether of one or more of a mono-, di-, or trihydric phenol; a glycidyl ether of one or more of a bisphenol A or bisphenol F; a glycidyl ether of a polynuclear phenol; an epoxy resin derived from diphenolic acid; a glycidyl ether of an aliphatic polyol; a glycidyl ester; a glycidyl epoxy containing a nitrogen atom; a glycidyl derivative of cyanuric acid; a glycidyl resin of a melamine; a glycidyl amine; a glycidyl triazine; a thioglycidyl resin; a silicon-glycidyl resin; a fluorine glycidyl resin; an epoxy resin derived from a mono-epoxy other than an epihalohydrin; an epoxy resin derived from a monoepoxy alcohol; an epoxy resin derived from a monoepoxy by ester interchange; an epoxy resin derived from a glycidaldehyde; a polyglycidyl compound containing unsaturation; or an epoxy resin that is synthesized from an olefin and a chloroacetyl; or any combination thereof;
wherein said amine of said tri-amine terminated polyalkylene oxide toughener, independently, is a primary amine or a secondary amine, wherein the amount of said tri-amine terminated polyalkylene oxide toughener is from about 5 to about 25 parts by weight per 100 parts by weight of said epoxy resin, wherein said polyalkylene oxide is derived from a total of about 30 to about 70 moles of said one or more alkylene oxides, wherein the weight average molecular weight of said tri-amine terminated polyalkylene oxide toughener is from about 2,500 to about 3,500, wherein the amount of said tri-amine terminated polyalkylene oxide toughener in said tri-amine-epoxy adduct compound is from about 15% to about 50% by weight;
wherein said amine of said amine terminated polyalkylene oxide tri-block polymer toughener, independently, is a primary amine, or a secondary amine, wherein the amount of said amine terminated polyalkylene oxide tri-block polymer toughener is from about 5 to about 25 parts by weight per 100 total parts by weight of said epoxy resin, wherein the weight average molecular weight of said amine terminated polyalkylene oxide tri-block polymer toughener is from about 1,000 to about 1,500, wherein the amount of said amine terminated polyalkylene tri-block polymer toughener in said tri-block-epoxy adduct compound is from about 15% to about 50% by weight;
wherein said amine of said di-amine terminated polyalkylene oxide toughener, independently, is a primary amine, or a secondary amine, wherein the amount of said di-amine terminated polyalkylene oxide toughener is from about 5 to about 25 parts by weight per 100 parts by weight of said epoxy resin, wherein the weight average molecular weight of said di-amine terminated polyalkylene oxide toughener is from about 1,500 to about 2,500, wherein the amount of said di-amine terminated polyalkylene oxide toughener in said di-amine-epoxy adduct compound is from about 15% to about 50% by weight; and
wherein said epoxy of the epoxy adducted CTBN copolymer is derived from an epoxy resin that has two end groups, wherein the weight amount of said carboxylated butadiene-acrylonitrile copolymer is from about 5 to about 25 parts by weight per 100 total parts by weight of said epoxy resin, and wherein the amount of said CTBN copolymer in said epoxy adducted-CTBN copolymer is from about 15% to about 50% by weight.

18. The uncured, epoxy blend composition of claim 17, wherein, independently, said epoxy of the tri-amine-epoxy adduct or said amine terminated tri-block polymer-epoxy adduct, or said di-amine adduct, is derived from neopentyl glycol diglycidyl ether, 1,4-butane diol diglycidyl ether, cyclohexanedimethanol diglycidyl ether, diglycidyl ether bisphenol A, or diglycidyl ether bisphenol F, or any combination thereof;
wherein the amount of said tri-amine terminated polyalkylene oxide toughener is from about 13 to about 18 parts by weight per 100 total parts by weight of said epoxy resins, wherein each said chain is derived from propylene oxide and wherein the total number of said propylene oxide moles is from about 40 to about 60 moles, wherein said terminal amine is a primary amine, wherein the weight average molecular weight of said tri-amine terminated polyalkylene oxide toughener is from about 2,800 to about 3,200; wherein the amount of said tri-amine in said tri-amine-epoxy adducted compound is from about 25% to about 50% by weight;
wherein the amount of said amine terminated polyalkylene oxide tri-block polymer toughener is from about 13 to about 18 parts by weight per 100 total parts by weight of said epoxy resins, wherein each said chain is derived from propylene oxide and wherein said tri-block polymer is a polypropylene oxide (PPO)-polytetramethylene oxide (PTMO)-polypropylene oxide (PPO) tri-block polymer having a mole ratio of (PPO) repeat groups to (PTMO) repeat groups of from about 2 to about 10, wherein each said terminal amine is a primary amine, wherein the weight average molecular weight of said amine terminated polyalkylene oxide tri-block polymer toughener is from about 1,000 to about 1,400; and wherein the amount of said amine tri-block polymer in said amine tri-block polymer-epoxy adducted compound is from about 25% to about 50% by weight;
wherein the amount of said di-amine terminated polyalkylene oxide toughener is from about 13 to about 18 parts by weight per 100 total parts by weight of said epoxy resins, wherein each said chain is derived from propylene oxide, wherein said terminal amine is a primary amine, wherein the weight average molecular weight of said di-amine terminated polyalkylene oxide toughener is from about 1,800 to about 2,200; wherein the amount of said di-amine in said di-amine-epoxy adducted compound is from about 25% to about 50% by weight;
wherein the amount of said carboxylated butadiene-acrylonitrile copolymer is from about 13 to about 18 parts by weight per 100 total parts by weight of said epoxy resins, and wherein the amount of said carboxylated butadiene-acrylonitrile copolymer in said epoxy adducted CTBN copolymer is from about 25% to about 50% by weight; wherein said epoxy adduct of said CTBN is derived from neopentyl glycol diglycidyl ether, 1,4-butane diol diglycidyl ether, cyclohexanedimethanol diglycidyl ether, diglycidyl ether bisphenol A, or diglycidyl ether bisphenol F, or any combination thereof;
wherein said epoxy resin is the diglycidyl ether of bisphenol A, or the diglycidyl ether of bisphenol F, or a combination thereof; and
wherein the viscosity of said uncured epoxy composition at 27° C. is about 100,000 to about 300,000 centipose.

19. The uncured, epoxy blend composition of claim 1, wherein said composition is cured and has an ASTM D-1876 minus 40° C. peel strength of at least about 160 Newtons per 25 millimeters.

20. The uncured, epoxy blend composition of claim 8, wherein said composition is cured and has an ASTM D-1876 minus 40° C. peel strength of about 225 to about 325 Newtons per 25 millimeters.

21. The uncured, epoxy blend composition of claim 9, wherein said composition is cured and has an ASTM D-1876 minus 40° C. peel strength of at least about 160 Newtons per 25 millimeters.

22. The uncured, epoxy blend composition of claim 14, wherein said composition is cured and has an ASTM D-1876 minus 40° C. peel strength of about 225 to about 325 Newtons per 25 millimeters.

23. The uncured, epoxy blend composition of claim 15, wherein said composition is cured and has an ASTM D-1876 minus 40° C. peel strength of at least about 160 Newtons per 25 millimeters.

24. The uncured, epoxy blend composition of claim 17, wherein said composition is cured and has an ASTM D-1876 minus 40° C. peel strength of at least about 175 Newtons per 25 millimeters.

25. The uncured, epoxy blend composition of claim 18, wherein said composition is cured and has an ASTM D-1876 minus 40° C. peel strength of about 225 to about 325 Newtons per 25 millimeters.
